(19) United States
(12) Patent Application Publication
(10) Pub. No.: US 2016/0004584 A1
(43) Pub. Date: Jan. 7, 2016

(54) METHOD AND COMPUTER SYSTEM TO ALLOCATE ACTUAL MEMORY AREA FROM STORAGE POOL TO VIRTUAL VOLUME

(71) Applicant: HITACHI, LTD., Tokyo (JP)

(72) Inventors: Takayuki NAGAI, Tokyo (JP); Masataka NAGURA, Tokyo (JP)

(73) Assignee: HITACHI, LTD., Tokyo (JP)

(21) Appl. No.: 14/767,083

(22) PCT Filed: Aug. 9, 2013
(86) PCT No.: PCT/JP2013/071651

§ 371 Date: Aug. 11, 2015

(51) Int. Cl. G06F 11/07; H04L 12/24

(52) U.S. Cl. CPC G06F 11/079; G06F 11/0709; G06F 11/0751; H04L 41/0636

(57) ABSTRACT

An exemplary event analysis method generates a topology, indicating a correlation between management objects corresponding to a correlation between events defined in selected event propagation model, from configuration management information. It generates, from the selected event propagation model and the topology, a causality indicating a correlation between the causal event identifying an identifier of the management object and the type of the event, and the derivative event sequentially taking place from the causal event. It, in generating the causality, identifies the type of the management object where the derivative event takes place and the type of the event, without identifying the identifier of the management object where the derivative event takes place, when the topology for identifying the identifier of the derivative event is ungeneratable. It performs an event analysis by comparing the generated causality and the event actually taking place at the management target apparatuses.

### BACKGROUND

The present invention is related to a management system arranged to manage a plurality of management target apparatuses, and an event analysis method performed by the management system.

In Patent Document 1, a management server which is arranged to determine a cause of a problem which takes place at a management target component of a computer system is disclosed. To be more specific, the management program of Patent Document 1 treats each type of failure taking place at the management target apparatus as an event, and stores information at an event DB. Further, the management program includes an analysis engine which is arranged to analyze the causal relationship of a plurality of failures taking place at the management target apparatus.

The analysis engine accesses a configuration DB which includes inventory information of the management target apparatus, and recognizes a component in the management target apparatus over a path of an I/O pathway as a group which is referred to as a “topology.” Then, the analysis engine applies, with respect to the topology, a failure propagation model (IF-THEN rule) which includes a preset conditional sentence and an analysis result in order to form a causality matrix.

The causality matrix includes a causal event which is a cause of a failure taking place at another apparatus, and a group of related events triggered thereby. To be more specific, an event which is registered as a root cause of a failure at a THEN portion of the failure propagation model is a causal event, while of all the events, which are registered at an IF portion and are not the causal event, are related events.

Patent Document 1: U.S. Pat. No. 7,107,185

### SUMMARY

The technology disclosed in Patent Document 1 generates the causality matrix by applying the failure propagation model to the topology. The technology, however, is unable to generate the causality matrix when the component over the path of the I/O pathway is not recognized as the topology due to an inability to acquire the configuration information from the management target apparatus. When the causality matrix is not generated, even when various types of failures are detected at the management target apparatus, the root cause thereof is not identified.

An aspect of the present invention is a management system arranged to mange a plurality of management target apparatuses and including a computation resource and a storage resource. The storage resource includes configuration management information arranged to store configuration information related to a plurality of management objects including the plurality of management target apparatuses and a plurality of components arranged at the plurality of management target apparatuses. The storage resource includes event propagation model management information arranged to store an event propagation model indicating, using a type of the management object and a type of an event, a correlation between a causal event and a derivative event taking place in a sequential manner from the causal event. The computation resource selects the event propagation model from the event propagation model management information. The computation resource generates a topology, indicating a correlation between a plurality of management objects corresponding to a correlation between a plurality of events defined in the selected event propagation model, from the configuration management information. The computation resource generates, from the selected event propagation model and the topology, a causality indicating a correlation between the causal event identifying an identifier of the management object and the type of the event, and the derivative event sequentially taking place from the causal event. The computation resource, in generating the causality, identifies the identifier of the management object where the derivative event takes place and the type of the event when the topology for identifying the identifier of the management object where the derivative event takes place is generatable from the configuration management information. The computation resource, in generating the causality, identifies the type of the management object where the derivative event takes place and the type of the event, without identifying the identifier of the management object where the derivative event takes place, when the topology for identifying the identifier of the derivative event is ungeneratable from the configuration management information. The computation resource performs an event analysis by comparing the generated causality and the event actually taking place at the plurality of management target apparatuses.

According to one embodiment of the present invention, it is possible to analyze the cause of an event which takes place at a management target system even when configuration information is not acquired from a management target apparatus from the management target system.

### BRIEF DESCRIPTION OF THE DRAWINGS

FIG. 1 is a schematic illustration describing an outline of an embodiment.

FIG. 2 is a diagram illustrating an example of a physical configuration of a computer system.

FIG. 3 is a diagram illustrating an example of a configuration of a host computer.

FIG. 4 is a diagram illustrating an example of a configuration of a storage apparatus.

FIG. 5 is a diagram illustrating an example of a detailed configuration of a management server.

FIG. 6 is a diagram illustrating an example of a configuration of a logical volume management chart which the host computer includes therein.

FIG. 7 is a diagram illustrating an example of a configuration of a volume management chart which the storage apparatus includes therein.

FIG. 8 is a diagram illustrating an example of a configuration of a file system management chart which the storage apparatus includes therein.

FIG. 9 is a diagram illustrating an example of a configuration of a file system—volume correlation management chart which the storage apparatus includes therein.

FIG. 10 is a diagram illustrating an example of a configuration of a RAID group management chart which the storage apparatus includes therein.

FIG. 11 is a diagram illustrating an example of a configuration of an event management chart which the management server includes therein.

FIG. 12A is a diagram illustrating an example of a configuration of an event propagation model which the management server includes therein.

FIG. 12B is a diagram illustrating an example of a configuration of an event propagation model which the management server includes.

FIG. 13A is a diagram illustrating an example of a configuration of a causality matrix which the management server includes therein.

FIG. 13B is a diagram illustrating an example of a configuration of a causality matrix which the management server includes therein.

FIG. 14 is a diagram illustrating an example of a configuration of a topology generation method management chart which the management server includes therein.

FIG. 15A is a diagram illustrating an example of a configuration of a configuration information acquirability management chart which the management server includes therein.

FIG. 15B is a diagram illustrating an example of a configuration of a configuration information acquirability management chart which the management server includes therein.

FIG. 16 is a flowchart illustrating an example of an entire flow of an apparatus information acquisition process which is executed by the management server.

FIG. 17 is a flowchart illustrating an example of an entire flow of an event confirmation process which is executed by the management server.

FIG. 18A is a flowchart illustrating an example of a flow of an event propagation model development process which is executed by the management server.

FIG. 18B is a flowchart illustrating an example of a flow of the event propagation model development process which is executed by the management server.

FIG. 18C is a flowchart illustrating an example of a flow of the event propagation model development process which is executed by the management server.

FIG. 18D is a flowchart illustrating an example of a flow of the event propagation model development process which is executed by the management server.

FIG. 18E is a flowchart illustrating an example of a flow of the event propagation model development process which is executed by the management server.

FIG. 19 is a diagram illustrating an example of a failure analysis result display screen which is displayed by the management server.

FIG. 20 is a flowchart illustrating an example of a flow of an event propagation model development process which is executed by a management server in an embodiment 2.

### DETAILED DESCRIPTION OF THE EMBODIMENTS

Hereinafter, embodiments of this invention will be described with reference to the accompanying drawings. In the following description, information in the embodiments will be expressed as “aaa table”, “aaa list”, “aaa queue”, “aaa matrix”, and the like; however, the information may be expressed in a data structure other than the table, list, queue, matrix and the like.

To imply independency from the data structure, the “aaa table”, “aaa list”, “aaa queue”, “aaa repository”, “aaa matrix” and the like may be referred to as “aaa information”.

Furthermore, in describing the specifics of the information, terms such as “identifier”, “name”, “ID”, and the like are used; but they may be replaced with one another. “Information” is used to express the content of data; however, another expression may be used.

In the following description, descriptions may be provided with subjects of “program” but such descriptions can be replaced by those having subjects of “processor” because a program is executed by a processor to perform predetermined processing using a memory and a communication port (communication control device). Furthermore, the processing disclosed by the descriptions having the subjects of program may be regarded as the processing performed by a computer such as a management computer or an information processing apparatus. A part or the entirety of a program may be implemented by dedicated hardware. Various programs may be installed in computers through a program distribution server or a computer-readable storage medium.

The present embodiment discloses a failure cause analysis performed at a management target system. According to the present embodiment, a management system retains configuration information and an event propagation rule concerning the management target system. Hereinafter, a management target apparatus and management target components which are included in the management target apparatus in the management target system are referred to as management objects. The configuration information identifies each management object via an identifier of the management object, and includes information concerning the correlation among the management objects.

The event propagation rule defines a relationship between a causal event of a failure and a derivative event, which derives from the causal event in a sequential manner. An event is defined by a type thereof and a type of the management object in which the event takes place. An event propagation model includes a metarule arranged to analyze failures.

The management system generates a causality concerning a failure taking place at the management target system by applying the configuration information to the event propagation rule. A causality is an analysis rule for performing a failure analysis at the actual management target system. The causality defines a correlation between a root cause event of a failure and a derivative event which takes place in a sequential manner from the cause event. The causality identifies a type of the causal event and an identifier of the management object at which the causal event takes place.

The causality identifies a type of each derivative event and an identifier of the management object at which the derivative event takes place when it is possible to acquire the configuration information of the derivative event. When it is impossible to acquire the configuration information of the derivative event, the causality identifies a type of the management object without identifying the identifier of the management object at which the derivative event takes place. Accordingly, it is possible to perform an analysis on a failure which takes place at the management target system even when it is impossible to acquire a portion of the configuration information corresponding to the event propagation rule.

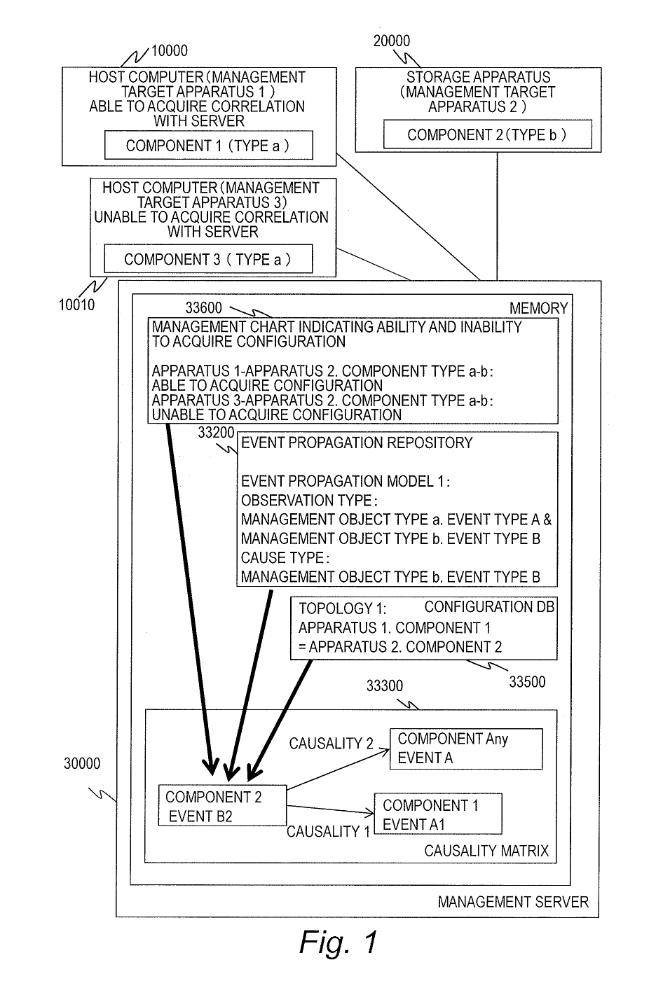

FIG. 1 is a diagram illustrating an outline of the present embodiment. A management server 30000 is a computer arranged to manage a plurality of management target apparatuses. The management target apparatus includes, for example, a host computer, a network apparatus such as an IP switch, a router, or the like, or an NAS (Network Attached Storage), a storage apparatus, or the like. The NAS is a server as well as a storage apparatus. FIG. 1 illustrates a host computer 10000 and a storage apparatus 2000 to exemplify the management target apparatus.

In the current disclosure, logical and physical components such as a device, or the like, which is included in the management target apparatus will be simply referred to as components. The component includes, for example, a port, a processor, a storage device, a program (file system and/or application), a virtual machine, a logical volume which is defined within the storage apparatus, a RAID group, or the like. Note that when the management target apparatuses and the components are described without clear distinction therebetween, they are referred to as management objects, en masse.

The management server 30000 acquires apparatus information which indicates the configuration, failures, and/or performances of the management target apparatuses, and displays, based on the acquired apparatus information, management information (for example, configuration information, whether or not failure is taking place, performance value, or the like) of the management target apparatuses.

For example, some of the management target apparatuses are the server apparatuses of a network service (for example, iSCSI or file sharing service, DNS, and other Web services), while other management target apparatuses, as client apparatuses, use the network services provided by these servers. For example, a storage access via an NFS (Network File System) protocol, which is an example of the network service, includes the host computer 1000 as a client apparatus and the storage apparatus 2000 as a server apparatus.

When a problem occurs at the server apparatus which is one of the management target apparatuses, a problem related to the management object occurs at the client apparatus which uses the server apparatus. For example, when a problem, such as a lockout of a volume or a performance failure, or the like, takes place at the storage apparatus 2000, a problem related to the management object also takes place at the host computers 10000 and 10010 which use the storage apparatus 2000.

In the following description, information which indicates a problem taking place at a management object will be referred to as an event. Further, expressions such as “detection of an event” represents “detecting problem taking place and generating event information.” It is to be noted that “event taking place” includes the same meaning as “problem taking place.”

The management server 30000 is operable to analyze that a cause of a problem taking place at a management target apparatus is a problem taking place at another management target apparatus, and display the same. Accordingly, the management server 30000 stores therein the following information and uses the same for analysis.

A configuration DB 33500 stores therein information which indicates the configuration of the management target apparatus. The configuration DB 33500 includes the correlation between the management objects, such as the components included at the management target apparatus, or the correlation between the components. The configuration DB 33500 includes an identifier of the server apparatus (or a component of the server apparatus) arranged to receive the network service in connection with the client apparatus.

For example, when providing a volume via an NFS (Network File System) protocol is included in the network service, the host computer 1000, which is the client apparatus, identifies an IP address or a file shared name as an identifier, and accesses a volume provided by the storage apparatus 2000, which is the server apparatus.

Further note that, as for the Web, the host computers 10000 and 10010 identifies an URL of the Web server as an identifier, and accesses the Web page provided by the Web server.

The configuration DB 33500 may also include, concerning server apparatuses, an identifier related the client apparatus, which is an access source. Note that such correlation among the plurality of management objects which expand within the management target apparatus and/or across the plurality of management target apparatuses is referred to as a topology.

An event propagation model repository 33200 stores information (hereinafter, simply referred to as an event propagation model) of at least one event propagation model. The event propagation model includes one or a plurality of observation type pairs, and one causal type pair.

The causal type pair includes a pair having a type (also referred to as management object causal type) of a management object and a type (also referred to as event causal type) of an event. The event causal type includes a type of an event which may possibly occur at a type of the management object defined by the management object causal type.

The observation type pair includes a pair having a type (also referred to as management object observation type) of the management object and a type (also referred to as event observation type) of an event. The event observation type includes a type of an event which may possibly be observed by a type of the management object defined by the management object observation type.

The observation type pair indicates, when an event defined by the causal type pair takes place, a type of event which needs to be observed. Each observation type pair indicates any one of the causal type pair, an event taking place directly due to the causal type pair and which needs to be detected, or an event taking place due to the causal type pair via another event and which needs to be detected. The causal type pair is a part of the observation type pair.

When all events of the observation type pair included in the event propagation model are detected, an event occurrence of a corresponding causal type pair may be estimated to be the cause. The higher the degree of agreement between the detected event and the observation type pair is, the higher the possibility that the event occurrence of the corresponding causal type pair is the cause.

An analysis process performed by the management server 3000 includes determining the causality based on the event propagation model and the topology, and adding such causality to a causality matrix 33300. The causality includes information which indicates, when a first event (causal event) takes place at a first management object, that another event (derivative event) is going to take place at another management object. The first management object is an instance that is identified. The management object at which the derivative event takes place is identified by the identifier thereof, or identified solely by the type thereof.

A condition which allows a conclusion that the first event is the cause includes, for example, detecting all derivative events related to the first event. Note that information concerning the causality may be expressed in a format different from the causality matrix as long as the above stated causality is presented. For example, a data structure which indicates the correlation between the causal event and the detected derivative event (another observation event) by using pointer information, which indicates the correlation, may be used to express the causality. Further, note that one or a plurality of derivative events may occur from one causal event.

The management server 30000 generates and updates the causality matrix 33300 in an on demand manner. In other words, the management server 30000 makes a determination as to whether or not the causality, which corresponds to a prescribed event which is detected but remains unanalyzed, is generated into the causality matrix. When the causality matrix is not yet generated, by using a topology related to the prescribed event and the event propagation model related to the prescribed event, the causality is generated into the causality matrix 33300, wherein a comparison is made between the event which actually takes place and the causality in order to perform the analysis on the prescribed event. Note that the causality may be generated in advance instead of generating the causality matrix in an on demand manner.

In an example of the event analysis, an event 2, which is going to be the cause of an event 1, which is detected, is identified. This identification may be accomplished by referring to the causality matrix 33300. The management server 30000 may display, along with information concerning the event 1, a message indicating that the event 1 is caused by the event 2 on a display device thereof.

In another example of the event analysis, an event 4, which is going to be caused (or potentially caused) by an event 3, which is detected, is identified. This identification may be accomplished by referring to the causality matrix 33300. The management server 30000 may display a message indicating that the event 4 is going to be caused (or potentially caused) by the occurrence of the event 3 on a display device thereof.

After detecting an event the management server 30000 adds a prescribed causality to the causality matrix 33300 based on (1) the event propagation model which includes the detected event in the observation type pair, and (2) the topology related to the component at which the detected event took place. Note that adding a causality to the causality matrix 33300 is also referred to as developing the causality.

Note that developing the causality at a turning point such as detecting an event as stated above is referred to as an on demand development. By virtue of the on demand development, it becomes possible to further reduce the size of the causality matrix even when performing an event analysis with respect to a large scale computer system and/or a complicated computer system.

After generating the causality matrix 33300, the management server 30000 makes a comparison between the events which took place in a prescribed period of time in the past and the causality matrix in order to calculate a certainty factor for each causality. The certainty factor indicates a ratio of events which actually took place in the predetermined period of time in the past out of a plurality of observation events which include the potential to take place in relation to the causal event at the causality.

It is to be noted that the reason for limiting the events taking place in the predetermined period of time in the past is because that a derivative event, which takes place related to a causal event, takes place almost simultaneously as the causal event, and that, even taking the lag time before the detection of such event at the management server 30000 in consideration, an occurrence period falls within a certain amount of time.

An example in FIG. 1 illustrates an outline in which an event B2 (type B) is actually detected at a component 2 (type b). In such situation, an event A1 (type A) which takes place at a component 1 (type a), and an event A3 (type A) which takes place at a component 3 (type a) occur (or potentially occur) due to the detected event B2.

The management server 30000, in order to obtain a causal relationship concerning the above stated events, generates, based on a topology 1 and an event propagation model 1, a causality 1 indicating that the cause for the event A1 (type A) taking place at the component 1 (type a) is the event B2 (type B) taking place at the component 2 (type b) in the on demand manner.

On the other hand, although the cause for the event A3 (type A) taking place at the component 3 (type a) is the event B2 (type B) taking place at the component 2 (type b), since there is no topology corresponding thereto, the causality therefor is not generated. This is because the configuration information, which indicates the topology between the type a component and the type b component, is not acquired from the device 3 which the component 3 belongs due to reasons such as lack of support for an API in acquiring information.

When the causality matrix is not generated, the management server 30000 is unable to identify the cause based on the causal relationship of the both events even when the event A3 (type A) and event B2 (type B) are detected.

In order to solve such problem, the present embodiment makes a determination as to whether or not it is possible to generate a topology which is necessary when generating a predetermined causality corresponding to an analysis target event based on a configuration information acquirability management chart 33600. The configuration information acquirability management chart 33600 is a chart arranged to manage an acquirability of the configuration information from each management target apparatus for each type of component. Note that the configuration information acquirability management chart 33600 is defined in advance by an administrator.

According to the example in FIG. 1, the configuration information acquirability management chart 33600 indicates that the configuration information acquirability management chart 33600 is unable to acquire the topology related to the component type a and component type b between the apparatus 3 and apparatus 2. Accordingly, the configuration information acquirability management chart 33600 generates a causality 2 which indicates that the cause of an event of the event type A taking place at the component type a is the event B2 taking place at the component 2 (type b). The causality 2 does not indicate the type of event taking place, the type of component, a specific apparatus and component (instance) where the event takes place.

Accordingly, when a topology, which is necessary when generating a causality corresponding to an analysis target event, is not generated for reasons such as lack of support for the API in acquiring information, or the like, a causality, which identifies solely the type of the apparatus or the type of the component (object) where an event takes place, and which does not identify the identifier of the apparatus or the component, is generated for the portions the topology is not generated. Accordingly, it becomes possible to improve the accuracy of the analysis, which uses the causality.

The present embodiment refers to the configuration information acquirability management chart 33600 so as to generate the causality. Further, as stated above, the present embodiment correlates only the events that actually take place within a predetermined amount of time. By this, it becomes possible to perform an event analysis accurately even when insufficient configuration information is acquired from a portion of apparatus.

The above is the outline of the present embodiment. While some embodiments will be described hereinbelow, it goes without saying that the present invention is not limited thereto.

### Embodiment 1

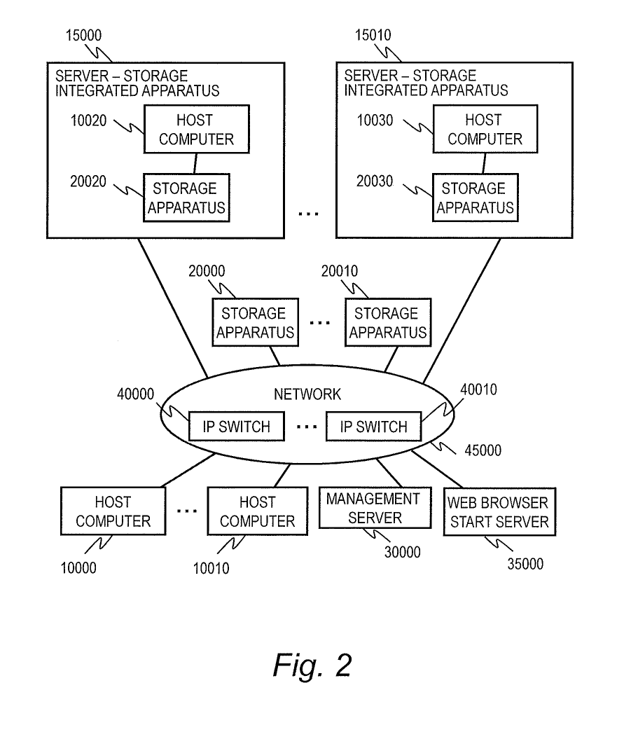

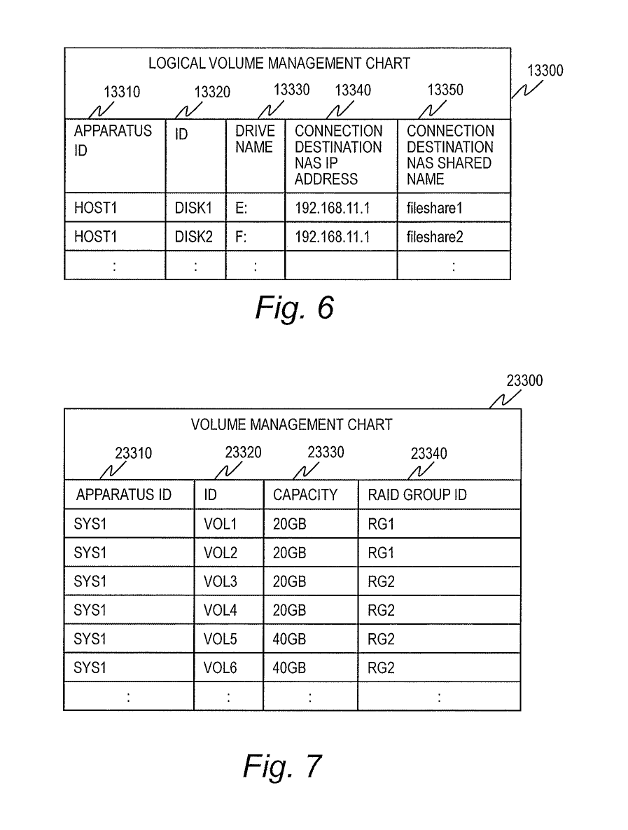

FIG. 2 to FIG. 5 each illustrate an example of a configuration of a computer system and an apparatus connected to the computer system. FIG. 6 to FIG. 15 each illustrate an example of management information included at each apparatus. FIG. 2 illustrates an example of a physical configuration of the computer system. The computer system includes storage apparatuses 20000 and 20010, host computers 10000 and 10010, the management server 30000, a Web browser start server 35000, an IP switch 40000, and server—storage integrated apparatuses 15000 and 15010. These are connected via a network 45000.

The host computers 10000 and 10010 receive an I/O request regarding a file from a client computer (unillustrated) which is connected to the host computers 10000 and 10010, and access the storage apparatus 20000 in response to the request, for example. Further, the management server (management computer) 30000 manages the operation of the entire computer system.

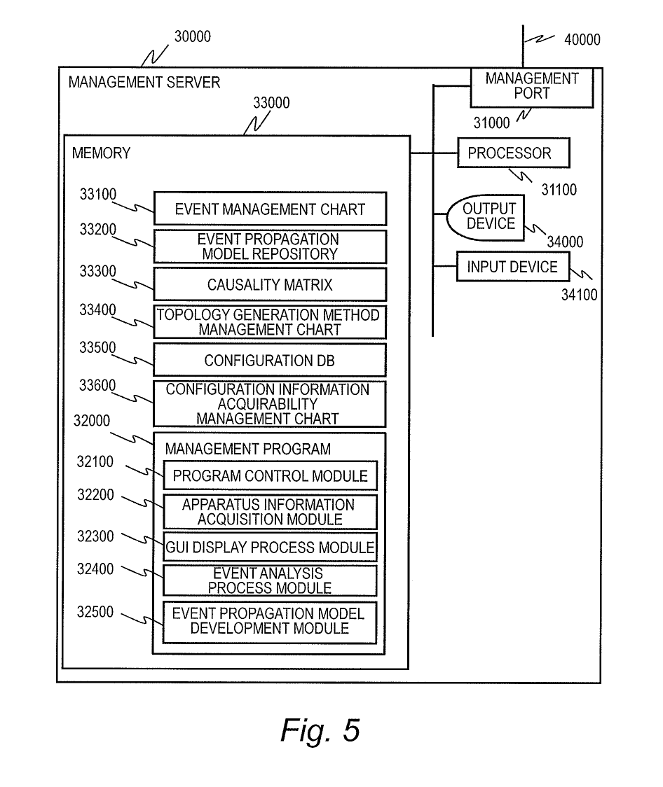

The Web browser start server 35000 communicates via the network 45000 with a GUI display process module 32300 (see FIG. 5) of the management server 30000, and displays each type of information on a Web browser. A user manages the apparatuses within the computer system by referring to the information displayed on the Web browser over the Web browser start server 35000. Note that the management server 30000 and the Web browser start server 35000 may be comprised of one computer.

The server—storage integrated apparatus 15000 includes a storage apparatus 20020 and a host computer 10020, which are connected via an internal bus. The server—storage integrated apparatus 15010 includes a storage apparatus 20030, and a host computer 10030, which are connected via an internal bus.

The server—storage integrated apparatuses 15000 and 15010 are managed by the management server 30000 equally as the host computers 10000 and 10010 and the storage apparatuses 20000 and 20010. In the description herein, a server portion and a storage portion of the server—storage integrated apparatuses 15000 and 15010 will be described as a host computer and a storage apparatus, respectively.

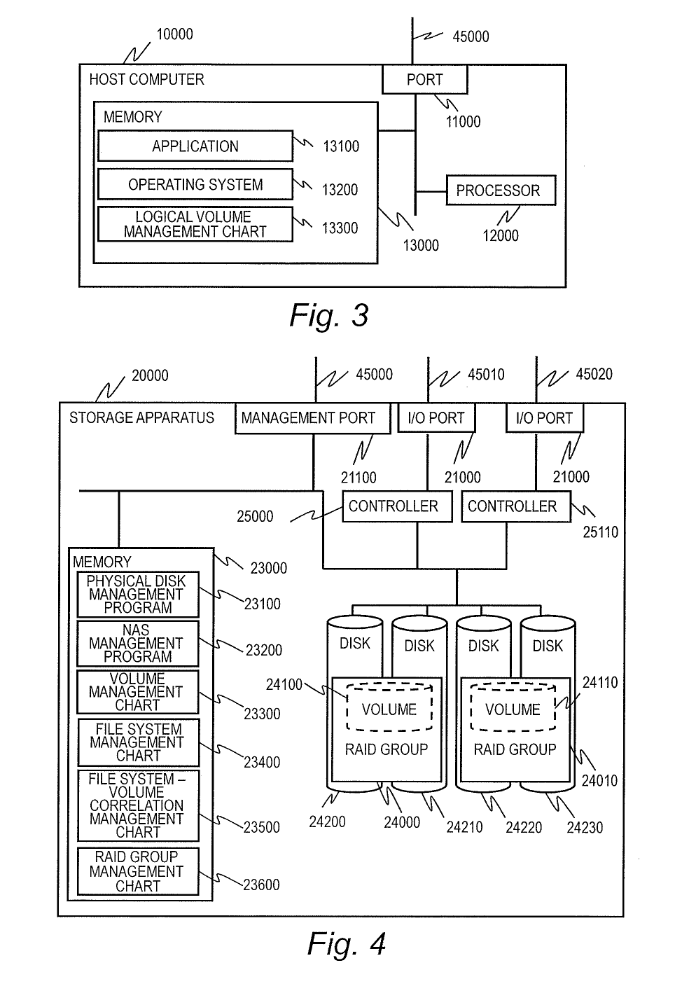

FIG. 3 illustrates an example of a configuration of the computer 10000. Note that the host computers 10001 to 10030 each include the same configuration as that of the host computer 10000. The host computer 10000 includes a port 11000, which is used to connect to the network 45000, a processor 12000, and a memory 13000 (may include a disk apparatus). These are connected to one another via a circuit such as an internal bus, or the like.

The memory 13000 stores therein a business application 13100, and operating system 13200, and a logical volume management chart 13300. The business application 13100 uses a storage area provided from the operating system 13200 so as to execute an input and output of data (hereinafter, noted as I/O) with respect to the storage area.

The operating system 13200 has the business application 13100 recognize that a volume, which is arranged at the storage apparatus 20000 connected via the network 45000 to the host computer 10000, is a storage area.

The port 11000 is depicted in FIG. 2 as a single port including an I/O port arranged to communicate with the storage apparatus 20000 via the NFS, and a management port arranged for the management server 30000 to acquire management information in the host computer. The I/O port may be arranged separately from the management port in order to communicate via the NFS.

FIG. 4 illustrates an example of an internal configuration of the storage apparatus 20000 according to the present embodiment. Note that the storage apparatuses 20010 to 20030 include the same configuration as that of the storage apparatus 20000. The storage apparatus 20000 includes I/O ports 21000 and 21010, a management port 21100, RAID groups 24000 and 24010, and controllers 25000 and 25010. These are connected to one another via a circuit such as an internal bus, or the like. Note that the connection with the RAID groups 24000 and 24010 indicates, to be more precise, a storage device including the RAID groups 24000 and 24010 connecting with another component.

The I/O ports 21000 and 21010 are connected to the host computer 10000 via the network 45000. The management port 21100 is connected to the management server 30000 via the network 45000. The management memory 23000 stores each type of management information. The RAID groups 24000 and 24010 are arranged to store data. The controllers 25000 and 25010 control the data and the management information in the management memory.

The management memory 23000 stores a management program. The management program includes a physical disk management program 23100, a NAS management program 23200, a volume management chart 23300, a file system management chart 23400, a file system—volume correlation management chart 23500, and a RAID group management chart 23600. The management program communicates, via the management port 21100, with the management server 30000, and provides the management server 30000 with the configuration information of the storage apparatus 20000.

The RAID groups 24000 and 24010 each include one or a plurality of magnetic disks. According to an example of FIG. 4, the RAID group 24000 includes magnetic disks 24200 and 240210, while the RAID group 24010 includes magnetic disks 24220 and 24230. The storage area of the RAID groups 24000 and 24010 are divided into a plurality of volumes 24100 and 24110.

Note that the volumes 24100 and 24110 do not necessarily form a RAID configuration as long as the volumes 24100 and 24110 are configured with the storage area including at least one magnetic disk. Further, as long as a storage area corresponding to the volume is provided, the storage device may use a storage medium other than the magnetic disk such as a flash memory, or the like.

The controllers 25000 and 25010 include therein a processor arranged to control the inside of the storage apparatus 20000, and a cache memory arranged to temporarily store therein data used for communicating with the host computer. The controllers 25000 and 25010 are arranged between the I/O ports 21000 and 21010, and the RAID groups 24000 and 24010, and arranged to receive and deliver data between one another.

The storage apparatus 20000 provides a volume to any one of the host computers. As long as the storage apparatus 20000 includes a storage control for receiving an access request (i.e., I/O request) and for reading from and writing to the storage device in response to the received access request, and the storage device for providing the storage area, the storage apparatus 20000 may include configuration other than what is described here.

For example, the storage device, which provides the storage controller and the storage area, may be stored in another housing. As for the example in FIG. 4, the management memory 23000 and the controllers 25000 and 25110 may be included in the storage controller.

FIG. 5 illustrates an example of an internal configuration of the management server 30000 according to the present embodiment. The management server 30000 includes a management port 31000 for connecting with the network 45000, a processor 31100, which is a computation resource, a memory 33000, which is a storage resource, an output device 31200 of a display device, or the like, for outputting a process result, which will be described below, and an input device 31300 such as a keyboard, or the like, for a storage administrator to input an instruction. These are connected to one another via a circuit such as an internal bus. The memory 33000 may include one or a plurality of types of devices as components thereof.

The memory 33000 stores a management program 32000. The management program 32000 includes a program control module 32100, an apparatus information acquisition module 32200, the GUI display process module 32300, an event analysis process module 32400, and an event propagation model development module 32500.

Although each module is provided as a program module of the memory 33000, each module may be provided as a hardware module. The management program 32000 may not be configured from modules as long as the management program 32000 is operable to realize the processes of each module.

In general, a program (including program module) executes a prescribed process by having a processor executing the program. Accordingly, hereinbelow, when the subject of the description is a program, the description may include a processor as the subject thereof. Or, a process executed by a program is a process carried out by an apparatus operated by the program or the system.

The processor operates as a functioning unit arranged to realize a predetermined function by operating in accordance with a program. For example, the processor functions as a management unit by operating in accordance with the management program 32000. This applies to other programs as well. The apparatus and the system, which include the processor, are the apparatus and the system which include these functioning units.

The memory 33000 further stores an event management chart 33100, the event propagation model repository 33200, the causality matrix 33300, a topology generation method management chart 33400, the configuration DB 33500, and the configuration information acquirability management chart 33600. The configuration DB 33500 stores the configuration information.

Examples of the configuration information include an item of the logical volume management chart 13300 collected from each host computer of the management target by the apparatus information acquisition module 32200, an item of the volume management chart 23300 collected from each storage apparatus of the management target, an item of the file system management chart 23400, an item of the file system—volume correlation management chart 23500, and an item of the RAID group management chart 23600.

The configuration DB 33500 does not necessarily store all of the charts of the management target apparatus, or all of the items in the charts. Further, the data representation format•data structure of each item stored in the configuration DB 33500 do no necessarily match the management target apparatus. When the management program 32000 receives information of each of these items from the management target apparatus, the management program 32000 may receive the data structure and the data representation format as in the management target apparatus.

The apparatus information acquisition module 32200 acquires information indicating a status of each component within the management target apparatus by accessing the management target apparatus in a periodic manner or in a repeated manner. The event analysis process module 32400 uses the causality matrix 33300 so as to analyze a root cause of an abnormal status (event) of the management target object detected by the apparatus information acquisition module 32200.

The GUI display process module 32300, in response to a request from an administrator inputted via the input device 31300, displays the acquired configuration management information via the output device 31200. Note that the input device and the output device do not need to be separate devices, and may be at least one unitary device.

Although the management server 3000 includes, for example, a display, a keyboard, and a pointer device, or the like, as the input/output device thereof, the management server 3000 may include other apparatuses. Further, as an alternative to the input/output device, a serial interface or an Ethernet interface may be used, where a computer for display purposes (for example, Web browser start server 35000) having a display, a keyboard, or a pointer device is connected to the interface so as to allow the computer for display purposes to display information by transmitting information intended for display to the computer for display purposes and by receiving information to be inputted from the display computer, or to substitute for the input/output device for inputting and displaying the information by receiving information.

It is to be noted that in the present specification, a set of more than one computer arranged to manage the computer system (information processing system) and to display information, which is intended for display, is occasionally referred to as a management system. When the management server 30000 displays information, which is intended for display, the management server 30000 is the management system, while the combination of the management server 30000 and the computer for display purposes (for example, Web browser start server 35000 in FIG. 1) is also the management system. Note that the storage resource and the computation resource of the management system each may include one or a plurality of types of devices and a plurality of devices.

Also note that, for high speed and high reliability of management processes, a plurality of computers may realize processes equivalent to those performed by the management server 30000. In a case where the plurality of computers are used, the plurality of computers (including the computer for display purposes when the same carries out display processes) are the management system.

FIG. 6 illustrates an example of a configuration of the logical volume management chart 13300 included at the host computer 10000. The host computer 10000 includes a plurality of configuration items. A field 13310 stores an identifier of the host computer. A field 13320 includes an identifier of each logical volume arranged at the host computer. A field 13330 stores a drive name for each logical volume.

A field 13340 stores an identifier of an IP address of the I/O port 21000 arranged at the storage apparatus used for communicating with the storage apparatus which includes a substance of the logical volume. A field 13350 stores a shared name which is an identifier of the file system at the storage apparatus which includes a substance of the logical volume.

FIG. 6 illustrates an example of specific values in the logical volume management chart included at the host computer. For example, the logical volume, which includes an identifier “DISK1” at a host computer “HOST1,” is indicated by a drive name “E:.” The logical volume is connected to the storage apparatus via a port of a storage apparatus, which is indicated by the IP address “192.168.11.1,” and includes a shared name “fileshare1” at the storage apparatus.

FIG. 7 illustrates an example of a configuration of the volume management chart 23300 included at the storage apparatus 20000. The volume management chart 23300 manages the volume in the storage apparatus 20000, and includes a plurality of configuration items. A field 23310 stores an identifier of the storage apparatus. A field 23320 includes a volume ID which is an identifier of each volume in the storage apparatus. A field 23330 stores a capacity of each volume. A field 23340 stores a RAID group ID which is an identifier of the RAID group to which each volume belongs.

FIG. 7 illustrates an example of specific values in the volume management chart included at the storage apparatus. For example, a volume “VOL1” at a storage apparatus “SYS1” includes “20 GB” of storage are, and belongs to an RAID group, which is indicated as “RG1.”

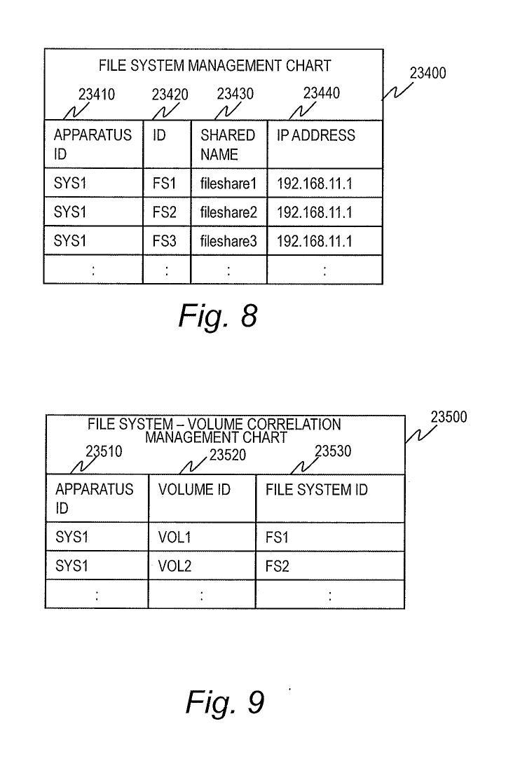

FIG. 8 illustrates an example of a configuration of the file system management chart 23400 included at the storage apparatus 20000. The file system management chart 23400 manages the file system in the storage apparatus 20000, and includes a plurality of configuration items. A field 23410 stores an identifier of the storage apparatus.

A field 23420 stores a file system ID which is an identifier of a file system in the storage apparatus. A field 23430 stores a shared name each file system includes. A field 23440 stores an IP address of the I/O port 21000 arranged at the storage apparatus used by each file system to communicate with the host computer.

FIG. 8 illustrates an example of specific values in the file system management chart included at the storage apparatus. For example, a file system “FS1” at a storage apparatus “SYS1” includes a shared name “fileshare1” and is connected to the host computer via a port at the storage apparatus which is indicated by an IP address “192.168.11.1.”

FIG. 9 illustrates an example of a configuration of the file system—volume correlation management chart 23500. The file system—volume correlation management chart 23500 manages the correlation between the file systems and the volumes in the storage apparatus 20000, and includes a plurality of configuration items.

A field 23510 stores an identifier of the storage apparatus. A field 23520 stores a volume ID which is an identifier of a volume in the storage apparatus. A field 23530 stores a file system ID which is an identifier of a file system in the storage apparatus which includes a substance for the volume.

FIG. 9 illustrates an example of specific values in the file system—volume correlation management chart included at the storage apparatus 20000. For example, the file system “FS1” at the storage apparatus includes the volume “VOL1” as a substance thereof.

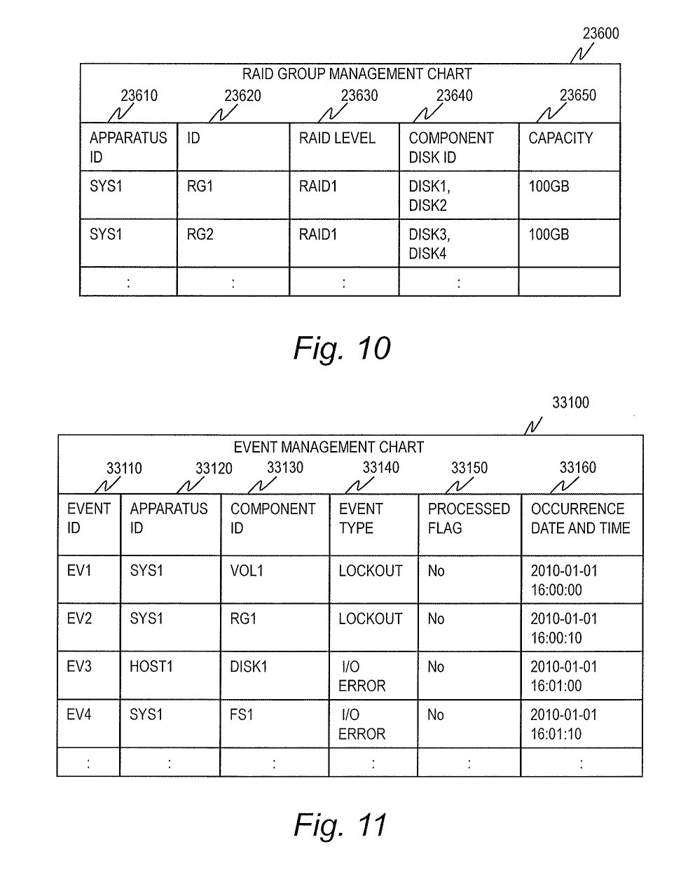

FIG. 10 illustrates an example of a configuration of the RAID group management chart 23600 included at the storage apparatus 20000. The RAID group management chart 23600 includes a plurality of configuration items. A field 23610 stores a RAID group ID which is an identifier of each RAID group in the storage apparatus. A field 23620 stores a RAID level of the RAID group. A field 23630 stores a capacity of each RAID group.

FIG. 10 illustrates an example of specific values in the RAID group management chart included at the storage apparatus 20000. For example, a RAID group “RG1” at the storage apparatus includes “RAID1” as a RAID level thereof, and a capacity of “100 GB.”

FIG. 11 illustrates an example of a configuration of the event management chart 33100 included at the management server 30000. The event management chart 33100 is event management information, and includes a plurality of configuration items. A field 33110 stores an event ID which is an identifier of an event itself. A field 33120 stores an apparatus ID which is an identifier of an apparatus at which an event such as a change in acquired configuration information takes place.

A field 33130 stores an identifier of a part of an apparatus at which an event took place. A field 33140 stores a type of an event which takes place. A field 33150 stores information indicating whether or not the event has already been processed by the event propagation model development module 32500, which will be described below. A field 33160 stores a time and date at which the event takes place.

For example, a first row (first entry) of FIG. 11 indicates that the management server 30000 detects an I/O error at a logical volume “DISK1” indicated as “E:” of the host computer “HOST1,” and that an event ID thereof is “EV1.”

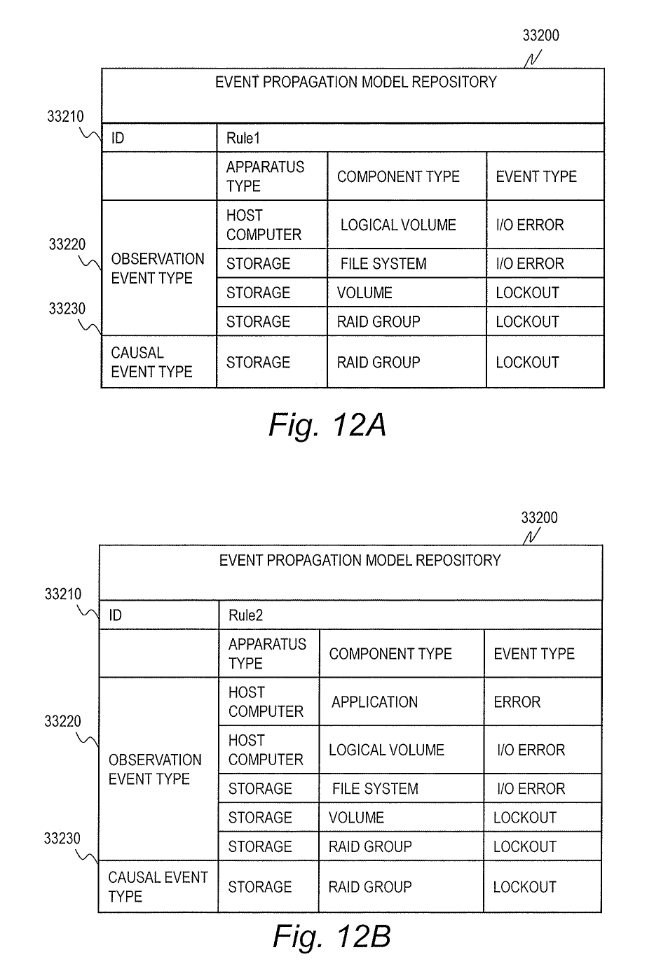

FIG. 12A and FIG. 12B each illustrate an example of an event propagation model in the event propagation model repository 33200 included at the management server 3000. The event propagation model, which is arranged to identify a root cause in a failure analysis, lists a combination of event types of the events anticipated to take place due to an occurrence of a failure, and an event type of the root cause in an IF-THEN format.

Note that the event propagation model is note limited to the examples shown in FIG. 12A and FIG. 12B. The event propagation model repository 33200 is operable to include more propagation models than what is shown in FIG. 12A and FIG. 12B. The event propagation model repository 33200 includes therein one or a plurality of event propagation models.

The event propagation model repository 33200 is event propagation model management information, and includes a plurality of items. A field 33210 stores a model ID which is an identifier of the event propagation model. A field 33220 stores an observation event type which corresponds to an IF portion of the event propagation model listed in the IF-THEN format. A field 33230 stores a causal event type which corresponds to a THEN portion of the event propagation model listed in the IF-THEN format. The observation type and causal event type are further fragmented to include the combination of an apparatus type, a component type, and an event type.

The observation event type stored at the field 33220 may be defined into a plurality of event types. The field 33220 includes at a bottom thereof an event type (agrees with the causal event type 33230) expressing a root cause for a series of failures.

When an effect of the root cause event spreads to another component and triggers another failure, the field 33220 stores, starting from the bottom thereof, the event types corresponding to the series of failures in an order the effect of the root causal event spreads. Note that this order is an order of events taking place.

That is to say, the component types expressed by the event type registered at the field 33220 are arranged such that the component types of a server side (side providing storage area, service, or the like) are at a bottom, while those of a client side (side receiving storage area, service, or the like) are at a top of the field. Continuous entries at the upper side indicate the client, while continuous entries toward the bottom indicate the client server. Note that as long as a causal relationship between events is displayable, information concerning each event may be stored in an order different from what is described above.

FIG. 12A and FIG. 12B each illustrate an example of specific values in the event propagation model included at the management server. For example, in FIG. 12A, an event propagation model whose model ID is indicated as “Rule1” concludes, upon detecting, as observation event types, an I/O error of a logical volume arranged at the host computer, an I/O error of a file system arranged at the storage apparatus, a lockout of a volume arranged at the storage apparatus, and a lockout of a RAID group arranged at the storage apparatus, that the failure of the RAID group arranged at the storage apparatus is the root cause.

The management server 30000 is operable to learn an order of events taking places by referring to the listed order of the events in the field 33220. In other words, it is possible to learn that the lockout of the RAID group arranged at the storage apparatus triggers the lockout of the volume, which then triggers the I/O error of the file system, which then triggers the I/O error of the file system.

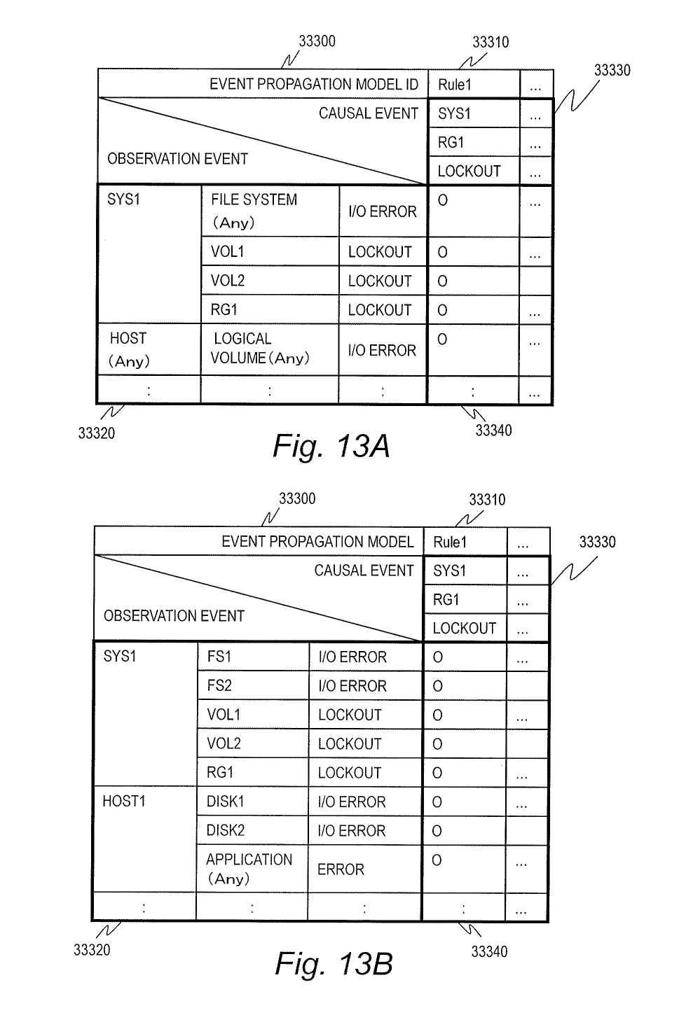

FIG. 13A and FIG. 13B each illustrate an example of a configuration of the causality matrix 33300 included at the management server 30000. The causality, which is added to the causality matrix 33300, is generated by applying topology information acquired from the configuration DB 33500 to the event propagation model in accordance with the topology generation management chart 33400.

The causality matrix 33300 includes the following information. A field 33310 stores an event propagation model ID which is an identifier of the event propagation model which is used while developing the causality. A field 33320 stores information which identifies an event configuring a causality. The field 33320 is operable to include the information of the event configuring the plurality of causalities in a single row. The field 33320 identifies an event, which the apparatus information acquisition module 32200 needs to detect for each causality. In FIG. 13A and FIG. 13B, an identifier of the management object (i.e., apparatus ID, component ID, event type) is stored.

A field 33330 stores, upon detecting an event, information indicating the causal event, which the event analysis process module 32400 concludes as the root of failures. In FIG. 13A and FIG. 13B, an identifier of the management object (i.e., apparatus ID, component ID, and event type) is stored.

A field 33340 indicates a configuration element of each causality, that is, an observation event which needs to be detected. In one example, a field having a circle indicates the observation event which configures the causality. In other words, in the field 33340, a single row expresses a single causality, that is, the correlation between an observation event which is actually detected and a causal event based on the event propagation model listed in the IF-THEN format.

In FIG. 13A and FIG. 13B, some portions of the charts where the apparatus ID and the component ID of the observation event are included include an operator “Any.” This indicates that the events, which take place at the apparatus and/or the component of the type, are regarded as having taken place irrespective of the ID. In other words, when a detected event satisfies the apparatus type, the component type, and the event type of one observation event in the event propagation model, such event corresponds to the observation event.

For example, in FIG. 13A, the observation event indicated as “host (Any), logical volume (Any), I/O error” is regarded as having already taken place and been detected when an I/O error is detected at an arbitrary logical volume of an arbitrary host computer. FIGS. 13A and 13B illustrate an example of specific values in the causality matrix included at the management server.

For example, in FIG. 13A, when the apparatus information acquisition module 32200 detects five events which correspond to an event propagation model Rule1, the event analysis process module 32400 concludes that the lockout of the RAID group RG1 arranged at the storage apparatus SYS1 is the cause (causal event).

The five events include the followings. A first is an I/O error of any one of logical volumes of any one of host computers. A second is an I/O error of any one of file systems of the storage apparatuses SYS1. A third is a lockout of the volume VOL1 of the storage apparatus SYS1. A fourth is a lockout of the volume VOL2 of the storage apparatus SYS1. A fifth is a lockout of the RAID group RG1 of the storage apparatus SYS1.

The causality matrix may include a data configuration allowing sizes of the lines to be modified dynamically in order to allow adding and deleting information more effectively. For example, the matrix may include sub matrix per certain rows or certain lines, where each is correlated via a pointer or an index to include a matrix in a virtual manner. The causality matrix may generate a matrix by using the continuous area of the memory 33000.

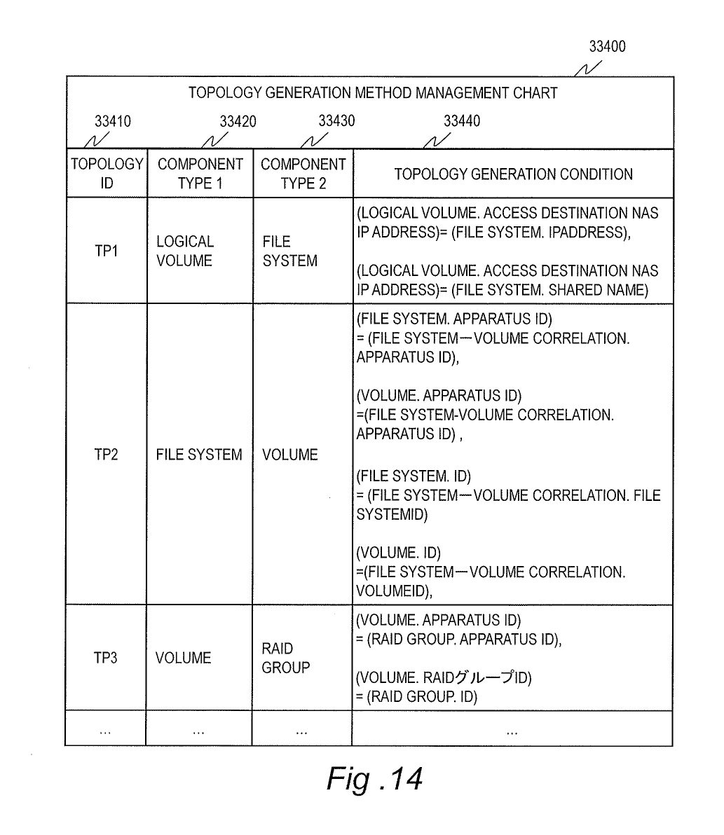

FIG. 14 illustrates an example of a configuration of the topology generation method management chart 33400 included at the management server 30000. The topology generation method includes information which defines a means to generate a connection relationship (topology) among a plurality of components which are the management target based on the configuration information, which the management server 30000 acquires from the management target apparatus.

The topology generation method management chart 33400 includes topology generation method management information, and a plurality of items. A field 33410 stores a topology ID which is an identifier of a topology. A field 33420 stores a component type of the component arranged at the management target apparatus which includes a starting point when generating a topology. A field 33430 stores a component type of the component which includes an end point when generating a topology. A field 33440 stores a topology generation condition between the starting point component and the end point component.

FIG. 14 illustrates an example of specific values in the topology generation method management chart 33400. For example, a topology, which includes the logical volume arranged at the host computer as a starting point thereof and a file system arranged at the storage apparatus as an end point thereof, is expressed by a topology ID “TP1.” This topology is acquirable by retrieving a combination in which an IP address of an NAS, which is a connection destination of the logical volume, is the same as an IP address of the file system, and an NAS shared name, which is a connection destination of the logical volume, is the same as a shared name of the file system.

Note that the IP address of an NAS, which is a connection destination of the logical volume, and the NAS shared name, which is a connection destination of the logical volume, are indicated in the logical volume management chart 13300. The IP address and the shared name included in the file system are indicated in the file system management chart 23400. Further, information concerning the condition indicated by the field 33440 is stored at the volume management chart 23300, the file system—volume correlation management chart 23500, and the RAID group management chart 23600. Information concerning these charts is stored at the configuration DB 33500.

For example, a topology which is expressed by a topology ID “TP2” includes a file system arranged at the storage apparatus as a starting point and a volume arranged at the storage apparatus as an end point. The generation condition of the topology includes that an apparatus ID of the file system and a file system ID in the file system management chart 23400 agree with the entries in the file system—volume correlation management chart 23500, and that an apparatus ID of a volume and a volume ID in the volume management chart 23300 agree with the above stated entries in the file system—volume correlation management chart 23500.

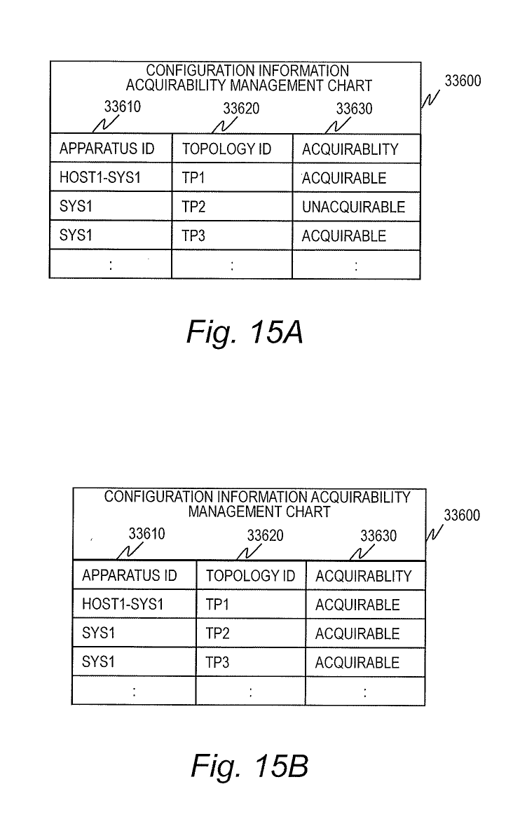

FIG. 15A and FIG. 15B each illustrate an example of a configuration of the configuration information acquirability management chart 33600 included at the management server 30000. The configuration information acquirability management chart 33600 includes configuration information acquirability management information, and a plurality of configuration items. A field 33610 stores an identifier of an apparatus such as the host computer or the storage apparatus. A field 33620 stores a topology ID which is an identifier of a topology. A field 33630 indicates whether or not a topology is acquirable at the apparatus. By virtue of the configuration information acquirability management chart 33600, it is possible to conveniently determine whether configuration information for generating a topology is acquirable or unacquirable in an appropriate manner.

FIG. 15 A and FIG. 15B each illustrate an example of specific values in the configuration information acquirability management chart 33600 included at the management server 30000. For example, in the configuration information acquirability management chart 33600 of FIG. 15A, a topology between HOST1-SYS1, which is indicated by a topology ID thereof, TP2, is acquirable, while a topology, which is indicated by a topology ID thereof, TP2, is unacquirable for the SYS1. In the configuration information acquirability management chart 33600 of FIG. 15B, each topology indicated by the respective topology IDs, TP1, TP2, TP3, is acquirable.

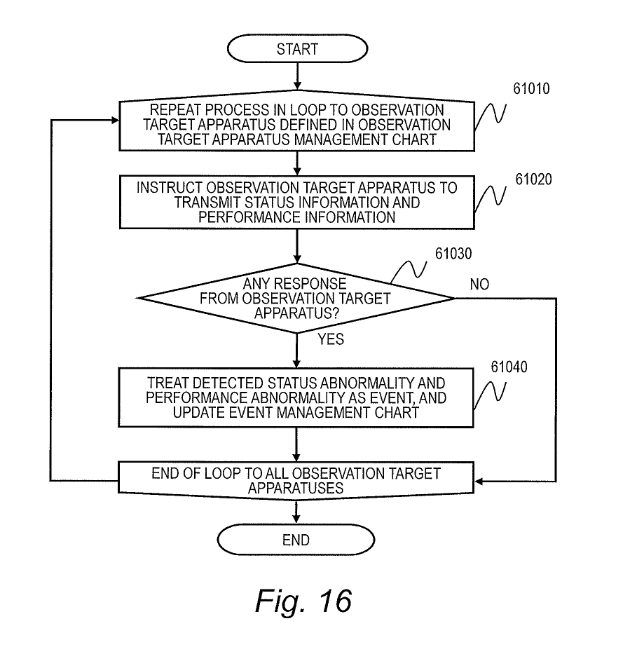

FIG. 16 illustrates a flowchart of an apparatus information acquisition process performed by the apparatus information acquisition module 32200 arranged at the management server 30000. The program control module 32100 gives an instruction with respect to the apparatus information acquisition module 32200 to execute the apparatus information acquisition process when starting a program, or each time after a predetermined amount of time has past since the previous apparatus information acquisition process.

Note that when issuing the execution instruction in a repeated manner, a period between each issuance does not need to be constant as long as the issuance is executed in a repeated manner. Further, information acquired from the apparatus includes the configuration information, status information and performance information of the apparatus. The apparatus information acquisition module 32200 may acquire each piece of the information one at a time separately.

In FIG. 16, the apparatus information acquisition module 32200 repeats a series of processes indicated below with respect to each of at least one management target apparatus (Step S61010). The apparatus information acquisition module 32200 gives an instruction with respect to a management target apparatus to transmit the configuration information, status information, and the performance information of the management target apparatus (Step 61020).

When a response is received from the apparatus (Step 61030), the apparatus information acquisition module 32200 treats a status abnormality and/or a performance abnormality detected during the acquisition of the apparatus information as an event, and updates the event management chart 33100 (Step 61040). Then, the apparatus information acquisition module 32200 stores the acquired configuration information at the configuration DB 33500 (Step 61050).

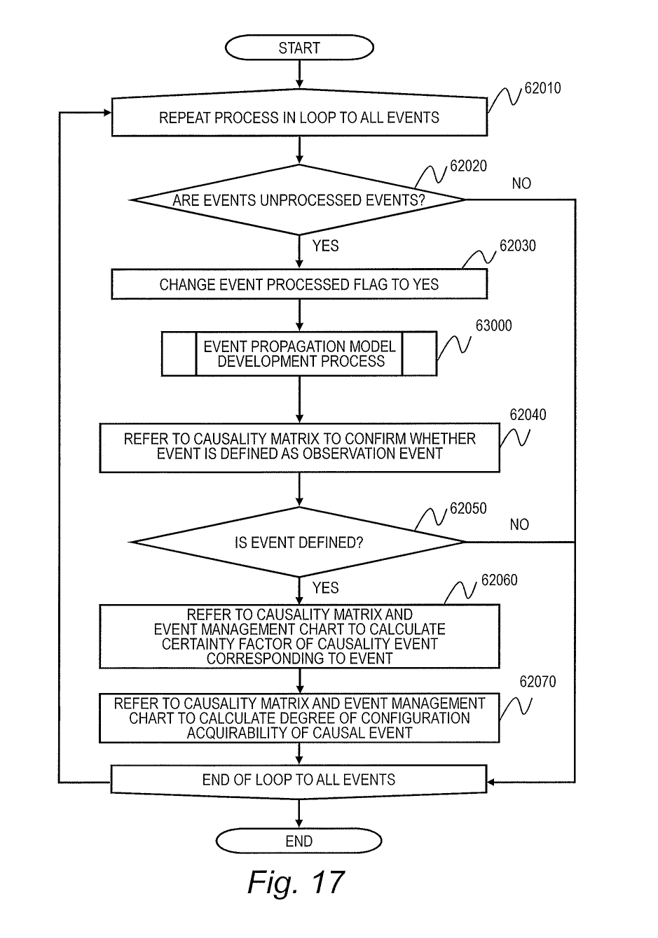

After completing the above stated process with respect to all management target apparatuses, the apparatus information acquisition module 32200 gives an instruction with respect to the event analysis process module 32400 to carry out an event confirmation process as illustrated in FIG. 17.

Note that in one example, when a status of a component changes into something other than normal, that which is treated as an event based on the status information generates an event (information) corresponding to the status after the change. In another example, when a performance value becomes something other than normal according to a prescribed evaluation standard (threshold, or the like), that which is treated as an event based on the performance information generates an event (information).

FIG. 17 illustrates a flowchart of the event confirmation process performed by the event analysis process module 32400 arranged at the management server 30000. The event analysis process module 32400 refers to the event management chart 33100 so as to repeatedly execute processes in a loop with respect to events stored in the event management chart 33100 (Step 62010).

The event analysis process module 32400 makes a determination as to whether or not the event selected from the event management chart 33100 is an unprocessed event (Step 62020). When a processed flag of the event indicates No, and the event is unprocessed (Step 62020: Yes), the event analysis process module 32400 executes Steps 62030 to 62070.

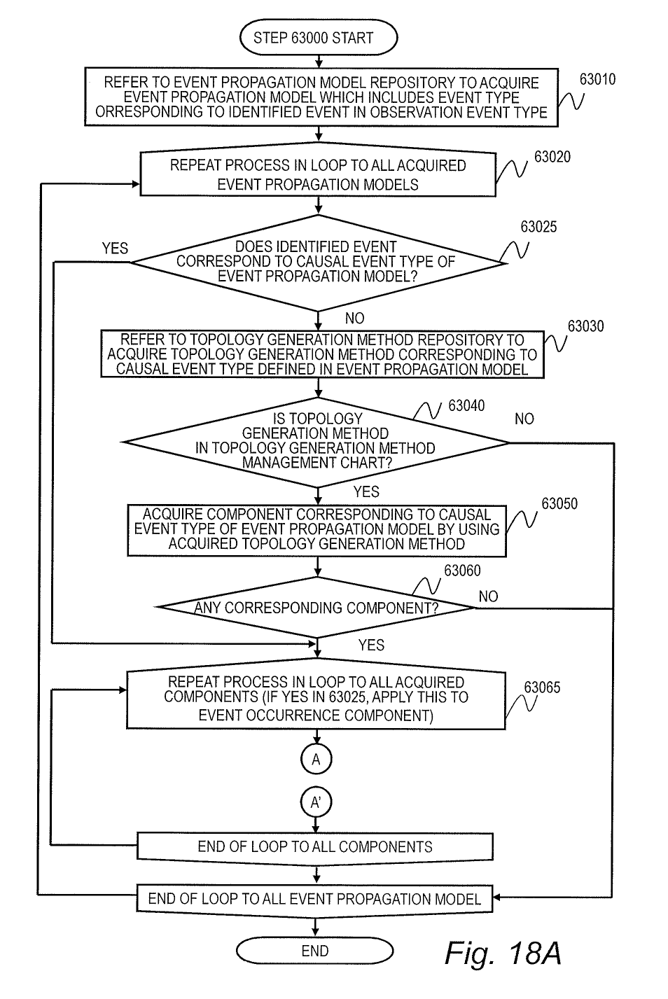

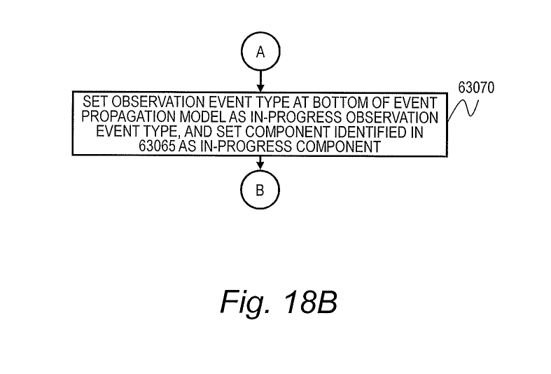

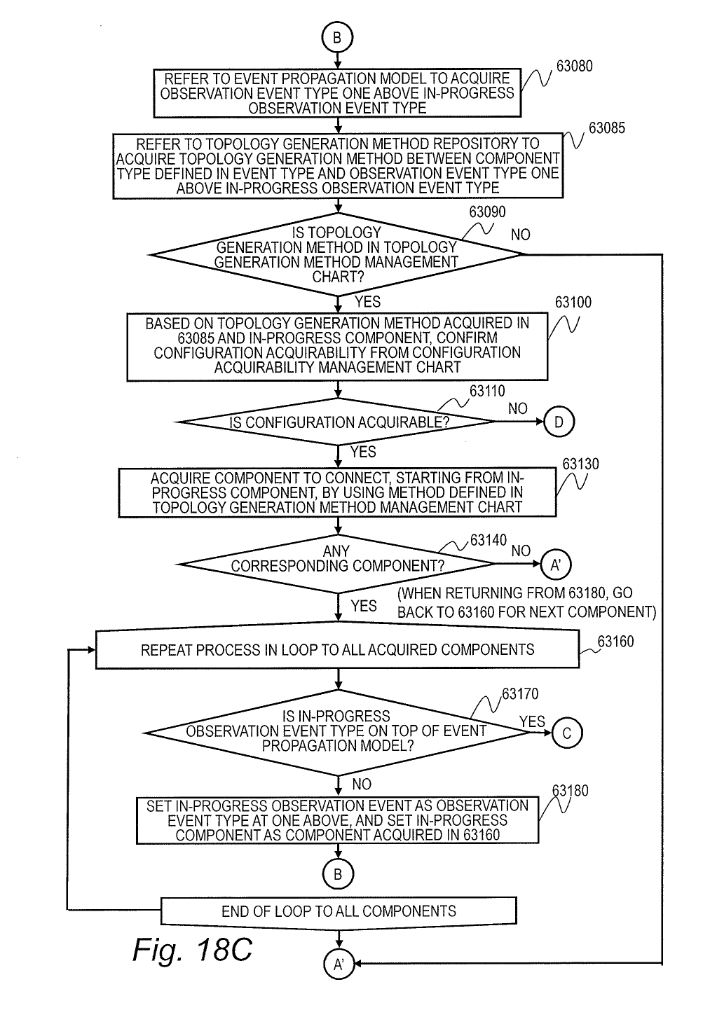

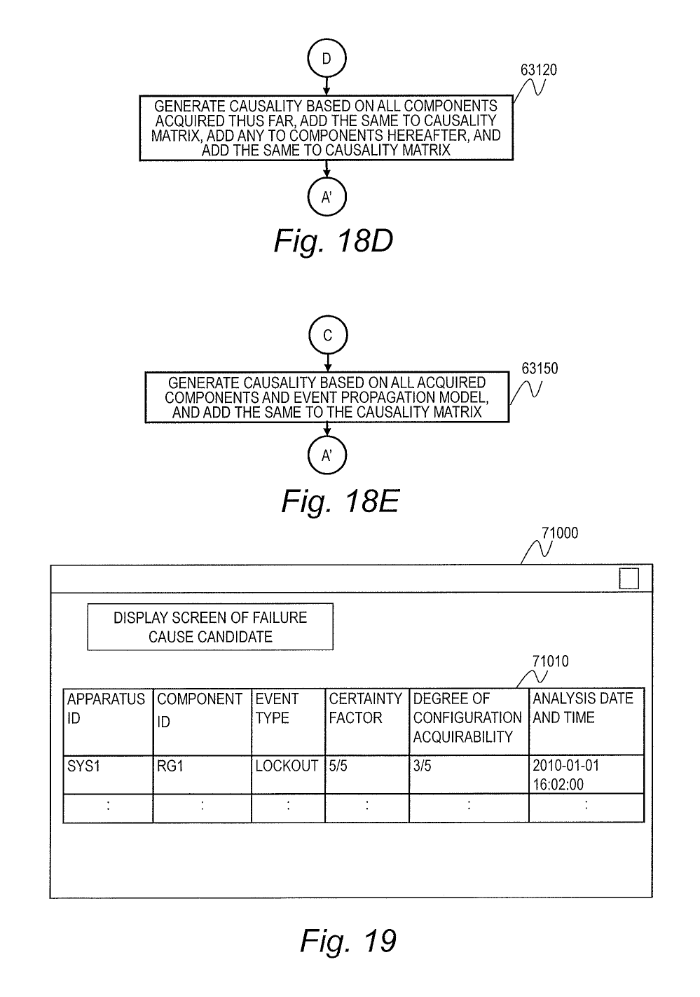

The event analysis process module 32400 changes the processed flag of the selected event to Yes in the event management chart 33100 (Step 62030). Next, the event analysis process module 32400 gives an instruction with respect to the event propagation model development module 32500 to identify the event and to execute an event propagation model development process (Step 63000) illustrated in FIGS. 18A to 18C.

When the event propagation model development process is finished (Step 63000), the event analysis process module 32400 refers to the causality matrix 33300 so as to determine whether the selected event is defined as an observation event (Step 62040). When the event is defines as the observation event (Step 62050: Yes), Steps 62060 to 62070 are executed.

The event analysis process module 32400 refers to the causality matrix 33300 so as to calculate the certainty factor of the causal event corresponding to the event (Step 62060). Next, the event analysis process module 32400 refers to the event management chart 33100 and the causality matrix 33300 so as to calculate a degree of configuration acquirability of the causal event (Step 62070).

Note that the certainty factor includes a ratio of events which have actually taken place in a predetermined period of time in the past in one causality. In other words, the certainty factor includes the ratio of events which have actually taken place in a predetermined period of time in the past out of the observation events corresponding to one causal event in the causality matrix. The event analysis process module 32400 retrieves an event corresponding to the observation event in the event management chart 31300.

The degree of configuration acquirability includes a ratio of events which identify the identifier of an object in one causality. In other words, the degree of configuration acquirability includes the ratio of events which identify the identifier of an object out of the observation events corresponding to one causal event in the causality matrix. According to the example of FIG. 13A and FIG. 13B, it is the ratio of the events which do not include the operator “Any” of the observation events.

Note that the event propagation model development module 32500 may be given an instruction such as to execute an on demand development of the event propagation model for a plurality of events.

FIGS. 18A to 18E each illustrate a flowchart of the event propagation model development process executed by the event propagation model development module 32500 arranged at the management server 30000. The event propagation model development module 32500 generates a causality including the identified event from each event propagation rule corresponding to the identified event.

According to the present example, the event propagation model development module 32500 further generates a causality which does not include the identified event from the same event propagation rule and the same causal event. All the generated causalities are added to the causality matrix 33300. This is because when there are multiple causalities having the same causal event, there is a high probability that the event by the causality which does not include the identified event may take place at the same time as when the identified event takes place. Accordingly, it is possible to realize an ideal failure analysis. The event propagation model development module 32500 may also be designed so as to only generate the causality that includes identified events as well.

The event propagation model development module 32500 selects an event propagation model corresponding to the identified event, and acquires the management object corresponding to the causal event of the event propagation model from the configuration DB 33500. Further, the event propagation model development module 32500 generates a topology corresponding to the relationship between events in an order of derivation starting from the causal event to a derivative event from the configuration information. The topology indicates an identifier of the management object which includes a relationship of use therewith.

When it is impossible to generate the topology from the configuration information of the configuration DB 33500, it is impossible to acquire an identifier (configuration information) of the management object of the event at a derivation destination (described below). In such case, the event propagation model development module 32500 identifies the type of the management object without identifying the identifier of the management object of the event. Further, the event propagation model development module 32500 identifies the type of the management object without identifying the identifier of the management object for all events thereafter for the event propagation model.

By generating a topology per event by the event propagation model, it becomes possible to work with various situations involving the events for which the configuration information of the causality is acquirable and unacquirable. Further, since the topology is generated in the order of derivation staring from the causal event, and since the type of management object is identified without identifying the identifier thereof with respect to the event for which the topology is ungeneratable and all events thereafter, it is possible to generate the causality which appropriately identifies the events which derive from the causal event.

In FIG. 18A, the event propagation model development module 32500 refers to the event propagation model repository 33200 so as to acquire a list of event propagation model which includes the event type corresponding to the event identified at the start of the process in the observation event type (Step 63010). Note that the list expresses one or a plurality of event propagation models.

The event propagation model development module 32500 repeats Steps 63030 to 63180 with respect to all of the acquired event propagation models (Step 63020). Note that when there is no corresponding event propagation model, the event propagation model development module 32500 ends the event propagation model on demand development process without executing the following steps.

The event propagation model development module 32500 makes a determination as to whether the event which is identified at the start of the process corresponds to the causal event type of the event propagation model which is identified in Step 63020 (Step 63025).

When the event corresponds to the causal event type (Step 63025: Yes), the event propagation model development module 32500 proceeds to Step 63065. When the event does not correspond to the causal event type (Step 63025: No), the event propagation model development module 32500 refers to the topology generation method management chart 33400 so as to acquire from the topology generation method management chart 33400 a topology generation method corresponding to the causal event type which is defined in the THEN portion of the event propagation model (Step 63030).

When the topology generation method repository does not include the corresponding topology generation method (Step 63040: No), the event propagation model development module 32500 does not execute the following processes. When the topology generation method repository includes the corresponding topology generation method (Step 63040: Yes), the event propagation model development module 32500, based on the acquired topology generation method, acquires from the configuration DB 33500 information of the component corresponding to the causal event type from the configuration DB 33500 (Step 63050).

When the configuration DB 33500 does not include the corresponding component (Step 63060: No), the event propagation model development module 32500 does not execute the following processes. When the configuration DB 33500 includes the corresponding component (Step 63060: Yes), the event propagation model development module 32500 repeatedly executes the processes after Step 63070 (FIG. 18B) with respect to all of the acquired components (Step 63065).

When it is determined in Step 63025 that the event which is identified at the start of the process corresponds to a conclusion event type of the event propagation model identified in Step 63020, the processes after Step 63070 (FIG. 18B) are executed with respect to the component at which the event takes place.

As illustrated in FIG. 18B, the event propagation model development module 32500 sets the observation event type which is defined (i.e., includes the component type same as that of causal event) at the bottom of the event propagation model as an in progress observation event type. Further, the component which is identified in Step 63065 as a process target is set as the in progress component (Step 63070).

With reference to FIG. 18C, the event propagation model development module 32500 refers to the event propagation model so as to acquire the observation event type which is arranged one above the in progress observation event type (Step 63080).

Next, the event propagation model development module 32500 refers to the topology generation method management chart 33400 so as to acquire the topology generation method between the component type which is defined in the event type and the component type of the observation event type at one above (Step 63085).

When the topology generation method management chart 33400 does not include the corresponding topology generation method (Step 63090: No), the event propagation model development module 32500 moves on to a next event propagation model without executing the processes up to Step 63180.

When the topology generation method management chart 33400 includes the corresponding topology generation method (Step 63090: Yes), the event propagation model development module 32500 makes a determination on the acquirability of the configuration information based on the topology generation method which is acquired in Step 63085 and the in progress component by referring to the configuration information acquirability management chart 33600 (Step 63100).

When the configuration information acquirability management chart 33600 indicates that the configuration information is unacquirable (Step 63110: No), the event propagation model development module 32500 executes Step 63120 illustrated in FIG. 18D.

At Step 63120, the event propagation model development module 32500 firstly adds the observation event related to the component acquired thus far to the causality matrix 33300.

Further, the event propagation model development module 32500, with respect to the components for which the configuration information is not yet acquired, identifies a component type and an Any operator without identifying the component ID of the observation event, and adds the same to the causality matrix 33300. When an apparatus ID is also unidentified, the event propagation model development module 32500 identifies the apparatus type and the Any operator without identifying the apparatus ID of the observation event, and adds the same to the causality matrix 33300.

Then, the event propagation model development module 32500 moves onto a next event propagation model without executing the processes up to Step 63180.

On the other hand, when the configuration information acquirability management chart 33600 indicates that the configuration information is acquirable (Step 63110: Yes), the event propagation model development module 32500 acquires, with the in progress component as a starting point, the component connected thereto from the configuration DB 33500 by using a method defined in the topology generation method management chart 33400 (Step 63130).

When the configuration DB 33500 does not include the corresponding component (Step 63140: No), the event propagation model development module 32500 moves onto a next event propagation model without executing the processes up to Step 63180.

When the configuration DB 33500 includes the corresponding component (Step 63140: Yes), the event propagation model development module 32500 repeatedly executes the following processes with respect to all of the acquired components (Step 63160).

When the observation event type is at the top of the event propagation model (Step 63170: Yes), the event propagation model development module 32500 executes Step 63150 illustrated in FIG. 18E. That is, the event propagation model development module 32500 adds the components acquired thus far to the causality matrix 33300.

On the other hand, when the observation event type is not at the top of the event propagation model (Step 63170: No), the event propagation model development module 32500 sets an observation event type arranged one above the observation event type in the event propagation model as the in progress observation event type. Further, the component selected in Step 63160 is set as the in progress component. Then, the processes after Step 63080 are executed in a recursive manner.

Note that when information other than the configuration DB 33500 separately stores a topology, the above stated process may be executed referring to the information. Note that although according to the above stated example, the topology is generated starting from a causal event to a derivative event in the order of occurrences thereof, the topology may be generated in a route different from the example.

FIG. 19 illustrates a display example 71000 of a failure analysis result display screen which the GUI display process module 32300 displays for a user via a browser arranged at the Web browser start server 35000.

The failure analysis result display screen 71000 is arranged to display an analysis result which is derived from an event confirmation process illustrated in FIG. 19 on a table 71010. For each analysis result, an ID of an apparatus which is a root cause and/or an ID of a component which is a root cause, an event type of the root cause, a certainty factor and a degree of apparatus acquirability with respect to the root cause, and a time of the analysis are displayed.

Although an example in FIG. 19 displays the certainty factor and the degree of configuration acquirability separately, the both may be displayed in a combined manner as “degree of analysis result reliability.” When the certainty factor and the degree of configuration acquirability are displayed in a combined manner, a calculation method for the degree of analysis result reliability may include the following.

(1) Display (certainty factor X degree of configuration acquirability) as the degree of analysis result reliability,
(2) As for a condition for inability to identify an object identifier, calculate the certainty factor on a premise that the event is not detected, and display the calculated certainty factor as the analysis result reliability.

Note that the GUI display process module 32300 may display, without calculating the certainty factor of the causality including the condition for inability to identify the configuration, the result based on another causality, for which the certainty factor is calculated, separately therefrom. In Step 63025, when the event which is identified at the start of the process does not correspond to the conclusion event type of the event propagation model identified in Step 63020, the event propagation model development module 32500 may end the event propagation model development process without executing Step 63030 and thereafter.

Hereinbelow, a method to generate a causality matrix will be described by using the computer system which corresponds to the information indicated in FIGS. 6 to 15B as an example. In the example below, it is presupposed that the management server 30000 is unable to acquire the file system—volume correlation management chart 23500, which is illustrated in FIG. 9, from the storage apparatus 20000. Also note that only the models illustrated in FIG. 12A is defined in the event propagation model. Also note that as for the configuration information acquirability management chart 33600 what is illustrated in FIG. 15A is defined. Also note that the causality matrix 33300 is in an initial state such that it does not include any information registered therein.

The program control module 32100, in accordance with an instruction from an administrator or a schedule setting via a timer, gives an instruction with respect to the apparatus information acquisition module 32200 to execute an apparatus information acquisition process. The apparatus information acquisition module 32200 logs in to management target apparatus sequentially so as to give an instruction to the apparatus to transmit the status information and the performance information of the apparatus.

When the above stated process is finished, the apparatus information acquisition module 32200 refers to the acquired status information and the performance information so as to update the event management chart 33100. Here, it is supposed that the lockout of the volume which is indicated via the IDs thereof such as SYS1 and VOL1 as illustrated in the first row of the event management chart 33100 of FIG. 11 is detected.

The event analysis process module 32400 gives an instruction, upon confirming that the above stated event is an unprocessed event, with respect to the event propagation model development module 32500 to identify the event and to execute the event propagation model development process by referring to the event propagation model repository 33200.

The event propagation model development module 32500 acquires a list of event propagation models corresponding to the event. According to the event propagation model repository 33200 illustrated in FIG. 12A, there is Rule1 as an event propagation model which includes an event of a lockout of a volume arranged at a storage apparatus as an observation phenomenon. Accordingly, it is necessary to develop such event propagation model.

The event propagation model Rule1 illustrated in FIG. 12A defines “lockout of RAID group arranged at storage apparatus” as a causal event type. Referring to the topology generation method management chart 33400 illustrated in FIG. 14, a topology generation method TP3 between the volume and a RAID group arranged at a storage apparatus is defined. The event propagation model development module 32500 acquires a topology between the volume VOL1 and the RAID group by using the topology generation method TP3.

The event propagation model development module 32500 refers to the information which corresponds to the volume management chart 23300 illustrated in FIG. 7 so as to retrieve the volume VOL1 of the storage apparatus SYS1 in the configuration DB 33500. The ID of the RAID group is RG1.

Next, the event propagation model development module 32500 refers to the information which corresponds to the RAID group management chart illustrated in FIG. 8 so as to retrieve an object whose ID is RG1 in the configuration DB 33500. Accordingly, the RAID group is discovered.

Based on the result from the above, there is, as one of the topologies which includes the logical volume of the host computer and the volume of the storage apparatus, a combination of the volume VOL1 of the storage apparatus SYS1 and the RAID group RG1. Then, the event propagation model development module 32500 generates the causality which includes “lockout of RAID group RG1 arranged at storage apparatus SYS1” as a causal event.

The event propagation model development module 32500 examines the observation event types of the event propagation model Rule1 from the bottom thereof in a sequential manner. “Lockout of volume arranged at storage apparatus” is arranged above “lockout of RAID group arranged at storage apparatus.” The topology generation method management chart 33400 illustrated in FIG. 14 defines the topology generation method TP3 between the volume and the RAID group arranged at the storage apparatus.

Accordingly, the event propagation model development module 32500 acquires the topology between the RAID group RG1 and the volume by using the topology generation method TP3. Firstly, referring to the configuration information acquirability management chart 33600 illustrated in FIG. 15A shows that the event propagation model development module 32500 is operable to acquire the configuration information by using the topology generation method TP3 for the apparatus SYS1.

Accordingly, in a method same as the method stated above, the event propagation model development module 32500 is operable to discover, as one of the topologies including the volume and the RAID group of the storage apparatus, the combination of the volume VOL1 and the RAID group RG1 of the storage apparatus SYS1, and the combination of the volume VOL2 and the RAID group RG1 of the storage apparatus SYS1.

Next, in the observation event type of the event propagation model Rule1, “I/O error of file system arranged at storage apparatus” is arranged above “lockout of volume arranged at storage apparatus.” The topology generation method management chart 33400 illustrated in FIG. 14 defines the topology generation method TP2 between the file system and the volume arranged at the storage apparatus.

The event propagation model development module 32500 acquires the topology between the volume VOL1 and the file system by using the topology generation method TP2. However, referring to the configuration information acquirability management chart 33600 illustrated in FIG. 15A shows that the event propagation model development module 32500 is unable to acquire the configuration information by using the topology generation method TP2 for the apparatus SYS1.

Accordingly, the event propagation model development module 32500 adds the observation event related to the component acquired thus far to the causality matrix 33300. Then, the event propagation model development module 32500, with respect to the components for which the configuration information is not yet acquired, identifies a component type and an Any operator without identifying the component ID of the observation event, and adds the same to the causality matrix 33300.

In other words, when “I/O error of logical volume (Any) arranged at host computer,” “I/O error of file system (Any) arranged at storage apparatus,” “lockout of volume VOL1 arranged at storage apparatus,” “lockout of volume VOL2 arranged at storage apparatus,” and “lockout of RAID group RG1 arranged at storage apparatus” take place as observation events, a pattern which concludes “lockout of RAID group RG1 arranged at storage apparatus” as a root cause is the development result (i.e., causality to be developed). This development result (causality) is added as a line in the causality matrix.

By virtue of the above stated process, the causality matrix related to the event propagation model Rule1 is generated as illustrated in FIG. 13A.

Next, the event analysis process module 32400 refers to the causality matrix illustrated in FIG. 13A so as to calculate the certainty factor of the causal event corresponding to the identified event. When the causality matrix 33300 is generated, out of all the observation events indicated in the causality matrix 33300 only “lockout of volume VOL1 arranged at storage apparatus” is actually taking place. Accordingly, the certainty factory is 1/5. Then, when the events indicated in the second row to the fourth row in the event management chart 33100 illustrated in FIG. 11 all take place, the calculated certainty factor is 5/5.

Next, the event analysis process module 32400 refers to the causality matrix 33300 so as to calculate the degree of configuration acquirability of the causal event. Since there are three events that do not include the Any operator out of the observation events defined in the causality matrix 33300, the degree of configuration acquirability is 3/5.

As stated above, according to the present embodiment even when it is impossible to acquire the configuration information of a portion of events of the event propagation model, it is possible to perform the analysis on the cause of the event which takes place in the management target system.

### Embodiment 2

Embodiment 2 describes another example of the event propagation model development process performed by the event propagation model development module 32500. According to embodiment 1, the event propagation model development module 32500 confirms, when acquiring a topology between components, with the configuration information acquirability management chart 33600 concerning the acquirability of the configuration information by the topology generation method in acquiring the topology.

When the configuration information acquirability management chart 33600 indicates that the configuration information is unacquirable, the event propagation model development module 32500 gives an Any operator to the observation event which is related to the component for which the topology is unacquirable, and adds the same to the causality matrix 33300. However, when acquiring the topology between the components is not anticipated from the start, and when a topology generation method is not defined, the process of giving an Any operator to the observation event related to the components and the process of adding the same to the causality matrix 33300 are not executed.

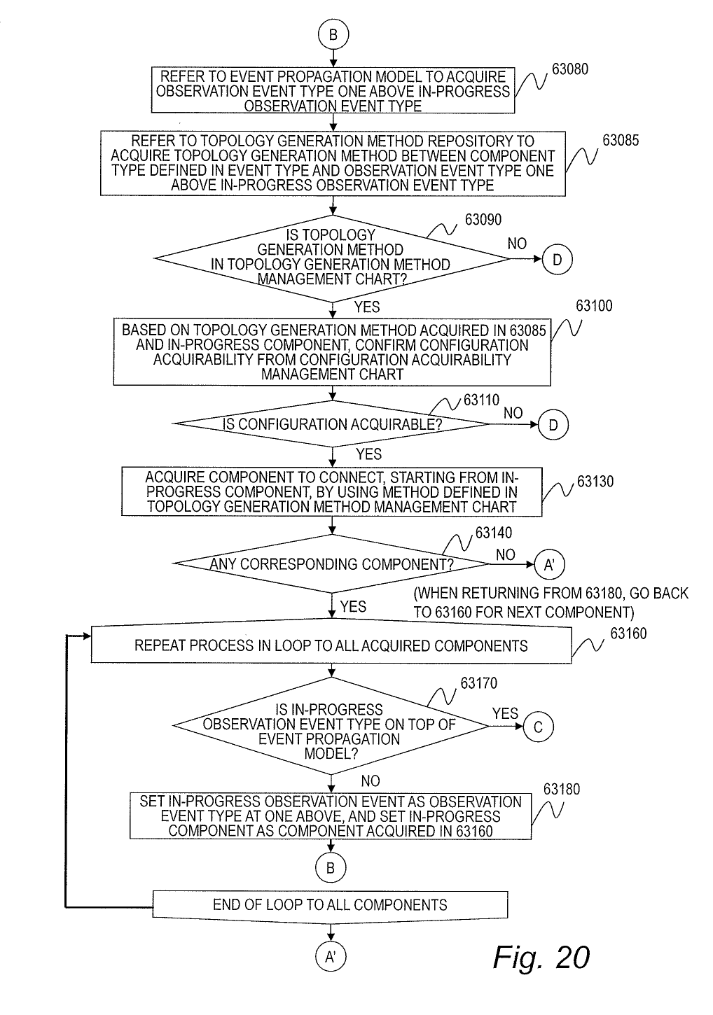

Embodiment 2 changes the event propagation model development process performed by the management server 30000. According to the present embodiment, when a topology generation method is not defined, a causality is generated by giving an Any operator to the observation event related to the component for which the topology generation method is not defined. The event propagation model development process including the change performed by the management server 30000 will be described with reference to FIG. 20. In the description hereinbelow, differences between embodiment 1 and embodiment 2 will be focused.

According to embodiment 2, a process, which is carried out when a determination result in Step 63090 is negative, is different compared to that in embodiment 1. In Step 63080, the event propagation model development module 32500 refers to the topology generation method management chart 33400 so as to acquire a topology generation method for the topology between the component type defined in the event type and the component type arranged one above the same.

When the topology generation method management chart 33400 does not include the topology generation method (Step 63090: No), the event propagation model development module 32500 moves to Step 63120. In other words, the event propagation model development module 32500 adds the observation event related to the component acquired thus far to the causality matrix 33300.

Further, the event propagation model development module 32500, with respect to the components for which the configuration information is not yet acquired, identifies a component type and an Any operator without identifying the component ID of the observation event, and adds the same to the causality matrix 33300. When an apparatus ID is also unidentified, the event propagation model development module 32500 identifies the apparatus type and the Any operator without identifying the apparatus ID of the observation event, and adds the same to the causality matrix 33300.

Hereinbelow, a method to generate a causality matrix will be described by using the computer system which corresponds to the information indicated in FIGS. 6 to 15B as an example. In the present embodiment, it is presupposed that only the event propagation model illustrated in FIG. 12A is defined, and that the configuration information acquirability management chart 33600 illustrated in FIG. 15B is defined, and that the causality matrix 33300 is in an initial state such that it does not include any information registered therein.

The program control module 32100, in accordance with an instruction from an administrator or a schedule setting via a timer, gives an instruction with respect to the apparatus information acquisition module 32200 to execute an apparatus information acquisition process. The apparatus information acquisition module 32200 logs in to a management target apparatus sequentially so as to give an instruction to the apparatus to transmit the status information and the performance information of the apparatus.

When the above stated process is finished, the apparatus information acquisition module 32200 refers to the acquired status information and the performance information so as to update the event management chart 33100. Here, it is supposed that the lockout of the volume which is indicated via the IDs thereof such as SYS1 and VOL1 as illustrated in the first row of the event management chart 33100 of FIG. 11 is detected.

The event analysis process module 32400 gives an instruction, upon confirming that the above stated event is an unprocessed event, with respect to the event propagation model development module 32500 to identify the event and to execute the event propagation model development process by referring to the event propagation model repository 33200.

The event propagation model development module 32500 acquires a list of event propagation models corresponding to the event. According to the event propagation model repository 33200 illustrated in FIG. 11, the same includes Rule2 as an event propagation model which includes an event of a lockout of a volume arranged at a storage apparatus as an observation event. Accordingly, it is necessary to develop such event propagation model.

The event propagation model Rule2 illustrated in FIG. 12B defines “lockout of RAID group arranged at storage apparatus” as a causal event type. Referring to the topology generation method management chart 33400 illustrated in FIG. 14, a topology generation method TP3 between a volume and a RAID group arranged at a storage apparatus is defined. The event propagation model development module 32500 acquires a topology between the volume VOL1 and the RAID group by using the topology generation method TP3.

As a result, similarly to embodiment 1, as one of the topologies which includes the logical volume of the host computer and the volume of the storage apparatus, a combination of the volume VOL1 of the storage apparatus SYS1 and the RAID group RG1 is acquired.

Accordingly, the event propagation model development module 32500 generates a causality, which includes “lockout of RAID group RG1 arranged at storage apparatus SYS1” as a causal event. The event propagation model development module 32500 examines the observation event types of the event propagation model Rule2 from the bottom thereof in a sequential manner.

“Lockout of volume arranged at storage apparatus” is arranged above “lockout of RAID group arranged at storage apparatus.” Referring to the topology generation method management chart 33400 illustrated in FIG. 14, the topology generation method TP3 between the volume and the RAID arranged at the storage apparatus is defined.

Accordingly, the event propagation model development module 32500 acquires the topology between the RAID group RG1 and the volume by using the topology generation method TP3. As one of the topologies which includes the volume and the RAID group arranged at the storage apparatus, the combination of the volume VOL1 and the RAID group RG1 of the storage apparatus SYS1, and the combination of the volume VOL2 and the RAID group RG1 of the storage apparatus SYS1 are discovered.

Next, between “I/O error of file system arranged at storage apparatus” and “lockout of volume arranged at storage apparatus” both of which are the observation event type of the event propagation model Rule2, and the former is defined above the latter.

The event propagation model development module 32500 acquires the topology between the volume VOL1 and the file system by using the topology generation method TP2. As a topology, which includes the file system and the volume of the storage apparatus, a combination of the file system FS1 and the volume VOL1 of the storage apparatus SYS1 is discovered.

In the same manner, the event propagation model development module 32500 acquires the topology between the volume VOL2 and the file system. As a topology, which includes the file system and the volume of the storage apparatus, a combination of the file system FS2 and the volume VOL2 of the storage apparatus SYS2 is discovered.

Next, between “I/O error of logical volume arranged at host computer” and “I/O error of file system arranged at storage apparatus” both of which are the observation event type of the event propagation model Rule2, and the former is defined above the latter.

The event propagation model development module 32500 acquires the topology between the file system FS1 and the logical volume by using the topology generation method TP1. As one of the topologies including the logical volume arranged at the host computer and the file system arranged at the storage apparatus, a combination of the logical volume DISK1 arranged at the host computer HOST1 and the file system FS1 arranged at the storage apparatus SYS1 is discovered.

In the same manner, the event propagation model development module 32500 acquires the topology between the file system FS2 and the logical volume. As one of the topologies including the logical volume arranged at the host computer and the file system arranged at the storage apparatus, a combination of the logical volume DISK2 arranged at the host computer HOST1 and the file system FS2 arranged at the storage apparatus SYS1 is discovered.

Next, “error of application arranged at host computer” is arranged above “I/O error of logical volume arranged at host computer.” Referring to the topology generation method management chart 33400 illustrated in FIG. 14, the topology generation method between the logical volume and the application arranged at the host computer is not defined.

Accordingly, the event propagation model development module 32500 adds the observation event related to the component acquired thus far to the causality matrix 33300. Then, with respect to the components for which the configuration information is not yet acquired, the event propagation model development module 32500 identifies a component type and an Any operator without identifying the component ID of the observation event, and adds the same to the causality matrix 33300.

In other words, when “error of application (Any) arranged at host computer HOST1,” “I/O error of logical volume DISK1 arranged at host computer HOST1,” “I/O error of logical volume DISK2 arranged at host computer HOST1,” “I/O error of file system FS1 arranged at storage apparatus SYS1,” “I/O error of file system FS2 arranged at storage apparatus SYS1,” “lockout of volume VOL1 arranged at storage apparatus,” “lockout of volume VOL2 arranged at storage apparatus,” and “lockout of RAID group RG1 arranged at storage apparatus” take place as observation events, a pattern which concludes “lockout of RAID group RG1 arranged at storage apparatus” as a root cause is the development result (i.e., causality to be developed). This development result (causality) is added as a line in the causality matrix.

By virtue of the processes above, the causality matrix related to the event propagation model Rule1 is generated as illustrated in FIG. 13B. According to the present embodiment, in addition to the effects of embodiment 1, when a topology generation method is not defined, the causality is generated by giving an Any operator to the observation event related to the component for which the topology generation method is not defined.

The present invention is not limited to the above-described examples but includes various modifications. The above-described examples are explained in details for better understanding of this invention and are not limited to those including all the configurations described above. A part of the configuration of one example may be replaced with that of another example; the configuration of one example may be incorporated to the configuration of another example. A part of the configuration of each example may be added, deleted, or replaced by that of a different configuration.

The above-described configurations, functions, and processing units, for all or a part of them, may be implemented by hardware: for example, by designing an integrated circuit. The above-described configurations and functions may be implemented by software, which means that a processor interprets and executes programs for performing the functions. The information of programs, tables, and files to implement the functions may be stored in a storage device such as a memory, a hard disk drive, or an SSD (Solid State Drive), or a storage medium such as an IC card, or an SD card.

What is claimed is:

1. A management system arranged to mange a plurality of management target apparatuses and including a computation resource and a storage resource,
wherein the storage resource includes configuration management information arranged to store configuration information related to a plurality of management objects including the plurality of management target apparatuses and a plurality of components arranged at the plurality of management target apparatuses, and
wherein the storage resource includes event propagation model management information arranged to store an event propagation model indicating, using a type of the management object and a type of an event, a correlation between a causal event and a derivative event taking place in a sequential manner from the causal event,
wherein the computation resource selects the event propagation model from the event propagation model management information,
wherein the computation resource generates a topology, indicating a correlation between a plurality of management objects corresponding to a correlation between a plurality of events defined in the selected event propagation model, from the configuration management information,
wherein the computation resource generates, from the selected event propagation model and the topology, a causality indicating a correlation between the causal event identifying an identifier of the management object and the type of the event, and the derivative event sequentially taking place from the causal event,
wherein the computation resource, in generating the causality, identifies the identifier of the management object where the derivative event takes place and the type of the event when the topology for identifying the identifier of the management object where the derivative event takes place is generatable from the configuration management information,
wherein the computation resource, in generating the causality, identifies the type of the management object where the derivative event takes place and the type of the event, without identifying the identifier of the management object where the derivative event takes place, when the topology for identifying the identifier of the derivative event is ungeneratable from the configuration management information, and
wherein the computation resource performs an event analysis by comparing the generated causality and the event actually taking place at the plurality of management target apparatuses.

2. The management system according to claim 1,
wherein the storage resource includes event management information arranged to manage information of the event actually taking place at the plurality of management target apparatuses,
wherein the selected event propagation model is the event propagation model corresponding to a first event selected from the event management information, and
wherein the causality generated by the computation resource includes the first event as the causal event or the derivative event.

3. The management system according to claim 2, wherein the computation resource performs the event analysis by comparing the generated causality and the event taking place in a predetermined period of time including a time point of the first event taking place.

4. The management system according to claim 1,
wherein the computation resource determines the identifier of the management object where the event takes place by acquiring the topology in accordance with an order of derivation starting from the causal event via the selected event propagation model, and
wherein the computation resource, when the topology for identifying the identifier of the management object where a second event takes place is acquirable from the configuration management information and when the topology for identifying the identifier of the management object where the event after the second event takes place is unacquirable from the configuration management information via the event propagation model, identifies the identifier of the management object where the second event and therebefore take place, and identifies, without identifying the identifier of the management object where the event after the second event takes place, the type of the management object and the type of the event via the causality.

5. The management system according to claim 4,
wherein the storage resource includes event management information arranged to manage information of the event actually taking place at the plurality of management target apparatuses,
wherein the selected event propagation model is a first event propagation model corresponding to a first event selected from the event management information, and
wherein the computation resource generates a plurality of the causalities including the causality including the first event and the causality not including the first event.

6. The management system according to claim 1, wherein the computation resource uses a degree of configuration acquirability indicating an event ratio identifying the identifier of the management object in the causality in the event analysis.

7. The management system according to claim 1,
wherein the storage resource includes configuration information acquirability management information arranged to indicate an acquirability of the configuration information for generating the topology from the configuration management information, and
wherein the computation resource determines, by referring to the configuration acquirability management information, whether the topology for identifying the identifier of the management object where the derivative event takes place is generatable from the configuration management information.

8. The management system according to claim 1,
wherein the storage resource includes topology generation method management information arranged to indicate a method for generating information configuring the topology from the configuration management information, and
wherein the computation resource, when the topology generation method management information does not include the method for generating the topology for identifying the identifier of the management object where the derivative event takes place, identifies the type of the management object where the derivative event takes place and the type of the event without identifying the identifier of the management object where the derivative event takes place.

9. An event analysis method performed by a management system arranged to manage a plurality of management target apparatuses,
wherein the management system includes configuration management information arranged to store configuration information related to a plurality of management objects including the plurality of management target apparatuses and a plurality of components arranged at the plurality of management target apparatuses, and
wherein the management system includes event propagation model management information arranged to store an event propagation model indicating, using a type of the management object and a type of an event, a correlation between a causal event and a derivative event taking place in a sequential manner from the causal event,
the event analysis method comprising:
selecting, by the management system, the event propagation model from the event propagation model management information;
generating, by the management system, a topology, indicating a correlation between a plurality of management objects corresponding to a correlation between a plurality of events defined in the selected event propagation model, from the configuration management information;
generating, by the management system, from the selected event propagation model and the topology, a causality indicating a correlation between the causal event identifying an identifier of the management object and the type of the event, and the derivative event sequentially taking place from the causal event;
in generating the causality, identifying, by the management system, the identifier of the management object where the derivative event takes place and the type of the event when the topology for identifying the identifier of the management object where the derivative event takes place is generatable from the configuration management information;
in generating the causality, identifying, by the management system, the type of the management object where the derivative event takes place and the type of the event, without identifying the identifier of the management object where the derivative event takes place, when the topology for identifying the identifier of the derivative event is ungeneratable from the configuration management information; and
performing, by the management system, an event analysis by comparing the generated causality and the event actually taking place at the plurality of management target apparatuses.
